(19) United States
(12) Patent Application Publication
(10) Pub. No.: US 2011/0124492 A1
(43) Pub. Date: May 26, 2011

(54) Multifunctional Nanocomposites

(76) Inventors: Nikolai Loukine, Toronto (CA); Anjan Das, Oakville (CA); Danielle Norton, Toronto (CA); Darren Anderson, Toronto (CA)

(21) Appl. No.: 12/885,215

(22) Filed: Sep. 17, 2010

Related U.S. Application Data
(60) Provisional application No. 61/243,349, filed on Sep. 17, 2009.

(51) Int. Cl. B01J 31/06; B01J 20/26; B01J 23/63; B01J 21/04; B01J 37/00; C08J 5/20; B82Y 30/00

(52) U.S. Cl. 502/159; 502/402; 502/304; 502/334; 502/354; 521/29; 977/773

(57) ABSTRACT

The present invention provides a multifunctional nanocomposite with at least two components, at least one component of which is a nanoparticle that includes a polymer.

### CROSS REFERENCES TO RELATED APPLICATIONS

This application claims priority to U.S. Provisional Patent Application Ser. No. 61/243,349 filed on Sep. 17, 2009, the entire contents of which are hereby incorporated by reference.

### BACKGROUND OF THE INVENTION

Nanocomposite materials are materials with at least one component phase with nanometer-sized dimension (0.1 to 100 nm). The nanoscale material phase may be metal or alloy, semiconductors, metal oxides, metal hydroxides, metal oxyhydroxide, or inorganic salts, polymer, organics, and the like, that can often possess unique characteristics because of their small size.

### SUMMARY OF THE INVENTION

In various aspects the present invention provides, a multifunctional nanocomposite comprising at least two components, at least one component of which is a nanoparticle comprising a polymer and the other component comprises an inorganic phase. In some embodiments, the polymer of the nanophase is crosslinked.

In various embodiments, the multifunctional nanocomposite is between 1 nm and 20 nm in size. In various embodiments, the multifunctional nanocomposite is less than 50 nm in size. In various embodiments, the multifunctional nanocomposite is less than 100 nm in size.

In various embodiments, the multifunctional nanocomposite is a polymer-stabilized inorganic nanoparticle. In various embodiments, the multifunctional nanocomposite includes a polyelectrolyte.

In various embodiments, the nanoparticle component is dispersed uniformly throughout the inorganic phase. In various embodiments, the nanoparticles are unevenly dispersed throughout the nanocomposite. In some embodiments, the nanoparticles are resistant to sintering at elevated temperatures.

In some embodiments, the secondary inorganic phase is selected from the group consisting of amorphous carbon, pyrolytic carbon, activated carbon, charcoal, ash, graphite, fullerenes, nanotubes and diamond. In some embodiments, wherein the secondary inorganic phase is selected from the group consisting of metal oxides, mixed metal oxides, metal hydroxides, mixed metal hydroxides, metal oxyhydroxides, mixed metal oxyhydroxides, metal carbonates, tellurides and salts. In some embodiments the secondary inorganic phase is selected from the group consisting of titanium dioxide, iron oxide, zirconium oxide, cerium oxide, magnesium oxide, silica, alumina, calcium oxide and aluminum oxide.

In various embodiments, the nanocomposite is porous. In various embodiments, the nanocomposite has a surface area greater than 100 m²/g. In various embodiments, the nanocomposite has a surface area greater than 150 m²/g. In various embodiments, the nanocomposite has a surface area greater than 200 m²/g.

In some embodiments, the nanocomposite contains multiple types of nanoparticle components. In various embodiments, the nanocomposite is a catalyst. In various embodiments, the nanocomposite includes multiple types of catalysts. In various embodiments, the nanocomposite is photocatalyst. In some embodiments, the nanocomposite is photocatalyst when exposed to visible light. In some embodiments, the nanocomposite is capable of producing hydrogen when irradiated with light. In various embodiments, the nanocomposite is an oxidation catalyst.

In some embodiments, the nanocomposite comprises more than 10% nanoparticle by weight. In various embodiments, the nanocomposite comprises more than 20% nanoparticle by weight. In various embodiments, the nanocomposite comprises more than 30% nanoparticle by weight.

In various embodiments, the nanocomposite comprises more than 30% polymer-stabilized nanoparticle by volume. In various embodiments, the nanocomposite comprises more than 20% polymer-stabilized nanoparticle by volume. In various embodiments, the nanocomposite comprises more than 10% polymer-stabilized nanoparticle by volume.

In some embodiments, the nanoparticle includes an inorganic phase stabilized by a polymeric phase. In various embodiments, the nanoparticle component is capable of sorption of organic substances. In various embodiments, the nanoparticle is capable of participating in ion exchange.

In some embodiments, the nanocomposite can remove more than 300 grams of charged contaminant from aqueous solution per gram of nanocomposite. In some embodiments, the nanocomposite can remove more than 100 grams of charged contaminant from aqueous solution per gram of nanocomposite. In some embodiments, the nanocomposite can remove more than 500 grams of charged contaminant from aqueous solution per gram of nanocomposite. In some embodiments, the nanocomposite can be used to remove arsenic from water.

In some embodiments, the nanocomposite can participate in cation exchange. In some embodiments, the nanocomposite can participate in anion exchange. In some embodiments, the nanocomposite can participate in both anion and cation exchange.

In various aspects the present invention provides, a nanocomposite including at least two components, one of which is inorganic, that is capable of being magnetically separated.

In various aspects the present invention provides a nanocomposite comprising at least two components, at least one component of which is a nanoparticle comprising a polymer and the second component comprising an inorganic phase, which is prepared by pyrolysis at a temperature >150° C. and sufficient to induce partial or complete decomposition of the polymer of the nanophase.

In various aspects the present invention provides a method to produce nanocomposite materials, including the steps of (a) dispersing nanoparticles in a suitable solvent; (b) adding at least one precursor component which can lead to the formation of an inorganic phase to the solvent; and (c) modifying the at least one precursor component of the inorganic precursor to form a nanocomposite.

In some embodiments, the nanoparticles are stabilized by polyelectrolytes. In some embodiments, the precursor component has an affinity for the nanoparticles. In some embodiments, the precursor component is a metal-containing ion. In some embodiments, the precursor component is a metal salt.

In some embodiments, the precursor component is selected from the group consisting of amorphous carbon, pyrolytic carbon, activated carbon, charcoal, ash, graphite, fullerenes, nanotubes and diamond. In some embodiments, the precursor component is selected from the group consisting of metal oxides, mixed metal oxides, metal hydroxides, mixed metal hydroxides, metal oxyhydroxides, mixed metal oxyhydroxides, metal carbonates, tellurides and salts. In some embodiments, the precursor component is selected from the group consisting of titanium dioxide, iron oxide, zirconium oxide, cerium oxide, magnesium oxide, silica, alumina, calcium oxide and aluminum oxide.

In various aspects the present invention provides a method to produce nanocomposite materials, comprising the steps of (a) dispersing nanoparticles in a suitable solvent; (b) adding an inorganic secondary phase to the dispersion; (c) adding an agent or combination of agents that promote interaction of the nanoparticles and the secondary phase; and (d) recovering the nanocomposite.

In some embodiments, the agent that promotes interaction of the nanoparticles and the secondary phase is a water-miscible solvent. In some embodiments, the agent that promotes interaction of the nanoparticles and the secondary phase comprises a salt or a salt solution. In some embodiments, the agent that promotes interaction of the nanoparticles and the secondary phase comprises an acid or base. In some embodiments, the agent that promotes interaction of the nanoparticles and the secondary phase comprises the application of electric current or electric potential.

In some embodiments, the method includes nanoparticles are stabilized by polyelectrolytes. In some embodiments, the precursor component has an affinity for the nanoparticles. In some embodiments, the precursor component is a metal-containing ion.

### BRIEF DESCRIPTION OF THE DRAWINGS

FIG. 1 shows a schematic of a nanocomposite wherein a nanometer-sized component such as a nanoparticle (1) is dispersed throughout a secondary phase (2)

FIG. 2 shows a schematic of a nanocomposite wherein a nanoparticle (1) is stabilized by a polymer (2) and is dispersed throughout a secondary phase (3)

FIG. 3 shows a method of making nanocomposites, comprising the steps of (a) dispersing nanoparticles (1) in a suitable solvent (2); (b) adding at least one precursor component (3) which can lead to the formation of an inorganic phase to the solvent (2), and (c) chemical modification of the at least one precursor to form a nanocomposite (4).

FIG. 4 shows a Field Emission Scanning Electron Microscopy (“FESEM”) image of a Bi₂O₃/PSS|Fe₃O₄ nanocomposite.

FIG. 5 shows an FESEM image of Fe₃O₄/PAA|Fe₃O₄ nanocomposite.

FIG. 6. Use of Nanocomposites in CO Oxidation, according to Example 50

FIG. 7. Use of Nanocomposites in Propylene Oxidation, according to Example 51

FIG. 8. Use of Nanocomposites in Oxidative Coupling of Methane, according to Example 52

FIG. 9. Use of Nanocomposites in Oxidative Dehydrogenation of Propane according to Example 53.

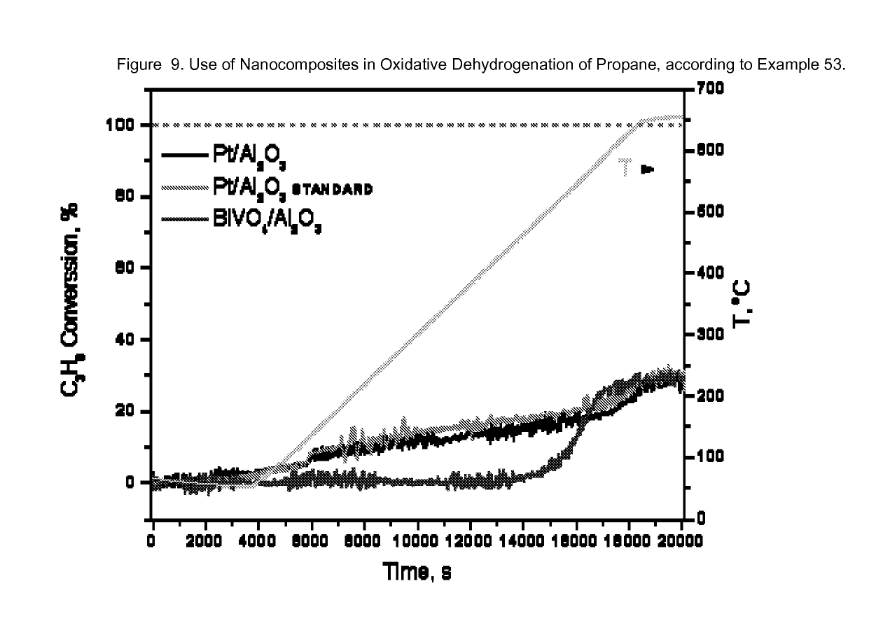

FIG. 10. Pore Size determination on Fe3O4/PAA|Fe3O4 nanocomposite from Example 18 using BET analysis (N2 sorption)

FIG. 11. Pore Size determination on Fe3O4/PAA|Al2O3 nanocomposite from Example 29 using BET analysis (N2 sorption)

### DETAILED DESCRIPTION OF EMBODIMENTS

In some embodiments of the present invention, nanocomposite materials are materials that comprise at least one component phase with nanometer-sized dimension (0.1 to 100 nm), the nanoscale material phase, or nanophase. The nanoscale material phase may comprise any one or more of components including metal or alloy, semiconductors, metal oxides, metal hydroxides, metal oxyhydroxide, metal salts, polymer, organics, and the like, that can often possess unique characteristics because of their small size. The nanoscale material phase can have a variety of shapes or orientations, and is referred to in this specification as a nanoparticle. The nanoparticle may be any shape generally (e.g., generally spherical, ellipsoidal, etc.,).

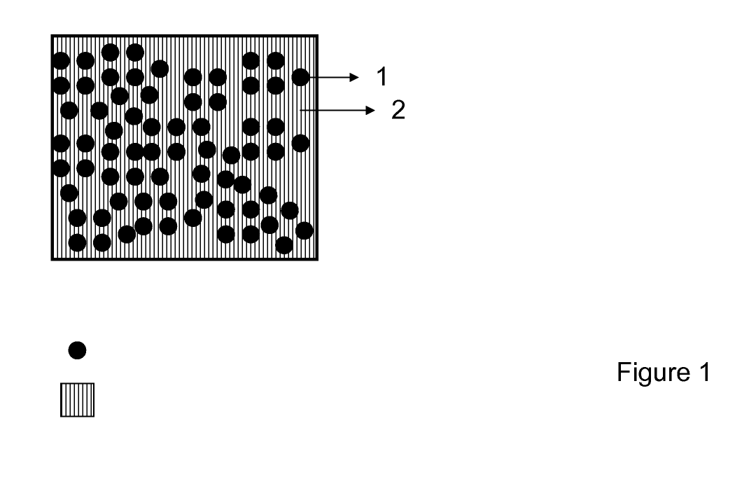

These nanocomposite materials also comprise at least a secondary phase. The secondary phase can be one or more bulk material phases, either continuous or discontinuous, or can be made up of one or more types of nanoscale materials. The nanoscale phase is dispersed, mixed, embedded or otherwise combined with the secondary phase. The secondary phase may be inorganic carbon (amorphous carbon, pyrolytic carbon, activated carbon, charcoal, ash, graphite, fullerenes, nanotubes or diamond), metal or alloy, metal oxide, metal hydroxide, metal oxyhydroxide, inorganic salts, semiconductors, polymer, organics, and the like, identical or different from the nanoscale material of the composite. FIG. 1 shows one embodiment of the present invention, wherein a nanometer-sized component such as a nanoparticle (1) is dispersed throughout a secondary phase (2) (e.g. inorganic phase). The secondary phase can also comprise nanoparticles that, taken together, form a secondary phase. Combined, the two phases form the nanocomposite. The nanocomposite material can have unique and multiple functions and thereby have significant commercial value.

The invention relates to composites, methods of making nanocomposite materials, and methods of using such composites.

In one aspect, the invention features nanocomposites that comprise a secondary inorganic phase and nanoparticles. The nanoparticles can be inorganic or polymeric in nature, or may comprise both inorganic and polymeric components.

In another aspect, the invention features methods of producing porous nanocomposite materials. This method can include the steps of (a) dispersing nanoparticles (i.e., the nanophase) in a suitable solvent; (b) adding at least one precursor component which can lead to the formation of an inorganic phase (i.e., the secondary phase) to the solvent; and (c) modifying the precursor component to form a nanocomposite. The modifying step can comprise creating a solid inorganic material phase wherein the nanophase component is entrapped, embedded or otherwise associated as part of a nanocomposite product.

The nanoparticles can be polymer-stabilized inorganic nanoparticles. In some embodiments, the polymer stabilizer includes one or more charged polymers or polyelectrolytes. The polyelectrolyte(s) can have a high molecular weight (e.g. greater than approximately 100,000 Daltons) or a low molecular weight (e.g. less than approximately 100,000 Daltons). The polymer or polyelectrolyte can be crosslinked. The polyelectrolyte can include ionized or ionizable groups. The polyelectrolyte can be cationic, anionic, or zwitterionic. The polyelectrolyte can include poly(allylamine hydrochloride) (PAAH), poly(diallyldimethylammonium chloride) (PDDA), poly(acrylic acid) (PAA), poly(methacrylic acid) (PMAA), poly(styrene sulfonate) (PSS), poly(2-acrylamido-2-methyl-1-propane sulphone acid) (PAMCS), chitosan, carboxymethylcellulose, and copolymers or mixtures thereof.

The polymer-stabilized inorganic nanoparticles can include a metal, an alloy, a mixed metal core-shell particle, a metal complex, a metal oxide, a metal hydroxide, a metal oxyhydroxide, or a metal salt. The inorganic nanoparticles can include doped or undoped Fe₂O₃, Fe₃O₄, CeO₂, Bi₂O₃, TiO₂, nitrogen doped TiO₂, BiVO₄, Au, Pd, Pt, MgF₂, SiO₂, Al(OH)₃, ZnO, or CdTe. Alternatively, the nanoscale inorganic materials can comprise metal atoms or clusters of atoms (Pd, Pt) on a mineral substrate, such as alumina or silica.

The nanoparticles can be polymer nanoparticles. The polymer component of the nanophase can be crosslinked. These polymer nanoparticles can be comprised of polyelectrolytes, and can contain metal salt counter-ions.

If a polymer, or other organic material is present in the nanophase, it can be pyrolyzed or otherwise burned off by heating to a suitable temperature. In certain embodiments, pyrolyzation modifies the properties of the nanocomposite (e.g., increases the porosity of the composite). In certain embodiments, the increase porosity is caused by evolution of gases e.g. H₂O vapor or CO₂ during burning of the polymer or partial or complete decomposition of the nanoparticle. As an example, if the nanoparticle contains CaCO₃, heating can cause the evolution of CO₂. In some embodiments, the temperature is such that the polymer in the nanoparticle is retained, while the nanoparticle core decomposes. The inorganic phase can include metal oxides, metal hydroxides, metal oxyhydroxides, metal salts, metal carbonates, metal sulfides, or insoluble metal salts. The inorganic phase can include e.g., Fe₃O₄, Fe₂O₃, TiO₂, ZnO, CaCO₃, SiO₂, CeO₂, Al₂O₃, Al(OH)₃, or hydroxyapatite.

The nanocomposite can include more than one secondary phase.

The nanocomposite can include more than one type of nanoparticle.

The nanoparticle can have an average particle size of approximately 1 nm to approximately 100 (e.g., 1 nm to 20 nm, 1 nm to 50 nm, 25 nm to 50 nm, 25 nm to 75 nm, 50 nm to 100 nm)

Embodiments may further include one or more of the following features or advantages.

The nanocomposites can be bi- or multi-functional. Functionality can be provided or determined by the different components of the nanocomposite. For example, the secondary (e.g., inorganic) phase can provide physical functionality such as, for example, susceptibility to magnetization. In the same nanocomposite, the nanophase (e.g., nanoparticle phase) can provide chemical functionality such as, for example, the ability to participate in ion exchange. The functionality imparted on the nanocomposite can be any physical or chemical functionality (e.g., can include: chemi- or physi-sorption; ion exchange; light absorption, diffusion, or emission; photocatalysis or other catalytic functions such as hydrogenation, hydrosilylation, CC-bond formation or oxidation; porosity; anti-microbial, bacteriostatic, and/or bactericidal or virocidal activity; anti-fouling; structural stability; heat stability; cell growth promotion; controls, sustained, triggered, or delayed release, etc., hydrophobe removal, among other functions). The nanocomposite can also be used as a pigment.

The nanocomposite can have a large surface area or can be highly porous. The surface area of the porous nanocomposite can be in the range from 1 to 300 m²/g or higher. High surface area materials can have improved mass transfer characteristics and can ensure that solvent borne materials can interact with both the secondary phase and the nanoscale phase of the nanocomposite material. High surface area and/or porosity allow for the appropriate reactions, associations or other useful interactions associated with the use of the nanocomposite material. Similarly, high surface area materials can have improved mass transfer characteristics for materials in a vapor phase.

The nanocomposite material of the invention can be used to remove heavy metals from water, for example. This can be accomplished when a functionality of the nanocomposite is the ability to participate in ion exchange. In another embodiment, functionality of the nanocomposite is the ability to physically or chemically absorb metal ions or complexes from water. In another embodiment, the nanocomposite can participate in both ion exchange and can absorb metal-containing species from water. The nanocomposite's participation in ion exchange can be to exchange ions with its surroundings, or to act as an acidic or basic catalyst. In one embodiment, the nanocomposite can be used to remove heavy metals including arsenic species, which are difficult to remove using other technologies. In one embodiment, this is accomplished by using a material as the inorganic phase that has an affinity for arsenic-containing species, and a nanoparticle that can participate in ion exchange. In one embodiment, the inorganic phase with an affinity for arsenic-containing species is an iron oxide or iron hydroxide. In certain embodiments, the iron oxide is ferric oxide, ferrous oxide or mixtures thereof including magnetite.

The nanocomposite can be catalytic. Catalytic functionality can be provided by either the inorganic phase or the nanoparticle. In certain embodiments, the nanocomposite can withstand high temperature applications (such as catalytic conversion) without sintering. The catalyst can be a photocatalyst. The catalyst can be an oxidation catalyst.

The nanocomposite can absorb hydrophobic substances. Sorption capacity can be provided by either the inorganic phase or the nanoparticle. In certain embodiments, the nanocomposite comprises a polymer nanoparticle that can absorb hydrophobic substances. In other embodiments, the inorganic secondary phase has sorption capacity, e.g. as with activated charcoal (carbon).

Other aspects, features, and advantages will be apparent from the following description of the embodiments and from the claims.

Compositions

Nanoparticles can have an average width or diameter from approximately 1 nm to approximately 100 nm. In certain embodiments, the nanoparticles have an average diameter, less than approximately 100 nm, less than approximately 75 nm, less than approximately 50 nm, less than approximately 20 nm, less than approximately 10 nm, less than approximately 5 nm. In some embodiments, the average width or diameter of the nanoparticles can range from approximately 1 nm to approximately 25 nm, from approximately 25 nm to approximately 50 nm, from approximately 50 nm to approximately 75 nm, from approximately 75 nm to approximately 100 nm, from approximately 1 nm to approximately 10 nm, or from approximately 1 nm to approximately 50 nm.

The nanoparticle can include a metallic conductor, a semiconductor, or an insulator. Examples of materials that can be included in the nanoparticle include elemental (i.e. formally zero-valent) metals, metal alloys, and/or metal-containing compounds (e.g., metal complexes, metal oxides, and metal sulphides). Specific examples of materials include, but are not limited to Fe₂O₃, Fe₃O₄, CeO₂, Bi₂O₃, Nitrogen doped TiO₂, BiVO₄, Au, Pd, Pt, Al(OH)₃, ZnO, CdTe. Identification of the crystal structure of the nanoparticle can be made using direct methods such as powder X-ray diffraction, or using indirect methods such as spectroscopy.

In some embodiments, the material(s) included in the nanoparticle or nanophase can include one or more dopants. The dopant can be used, for example, to modify the electronic properties of the nanoparticle. For example, while semiconducting titanium oxide (e.g., TiO₂) can adequately photocatalytically dissociate organic components using ultraviolet light, doping the semiconductor titanium oxide with certain elements or ions can make the semiconductor photocatalytic under visible light and more versatile. Examples of dopants include, for example, nonmetal compounds, metal compounds, nonmetal atoms, metal atoms, nonmetal ions, metal ions, and combination thereof. Specific examples of dopants include, but are not limited to, nitrogen, iodine, fluorine, iron, cobalt, copper, zinc, aluminum, gallium, indium, lanthanum, gold, silver, palladium, platinum, aluminum oxide, and cerium oxide. Examples of doped materials include doped bismuth materials (e.g., bismuth oxide doped with nitrogen, iodine, fluorine, zinc, gallium, indium, lanthanum, tungsten, tungsten oxide, and/or aluminum oxide), doped titanium materials (e.g., titanium oxide doped with nitrogen, iodine, fluorine, metal ions, zero-valent metals, and/or oxides such as metal oxides (e.g., zinc oxide), aluminum oxide, and silicon oxide). Dopants can be in a range of approximately 1-10 mol %, 0.1-1 mol %, or 0.01-0.1 mol %.

The nanocomposite can include nanoparticles of the same composition or different compositions. Within one nanocomposite, all the nanoparticles can have the same composition, or alternatively, some nanoparticles can have a first composition, while other nanoparticles can have a second composition different from the first composition. Further, the first nanoparticles and the second nanoparticles can be within only the nanophase, or one type may be within the nanophase and the other with in the secondary phase. Additionally, the secondary phase can include two or more different types of nanoparticles, which can be the same or different types of nanoparticles, or the same or different from the nanoparticles in the nanophase.

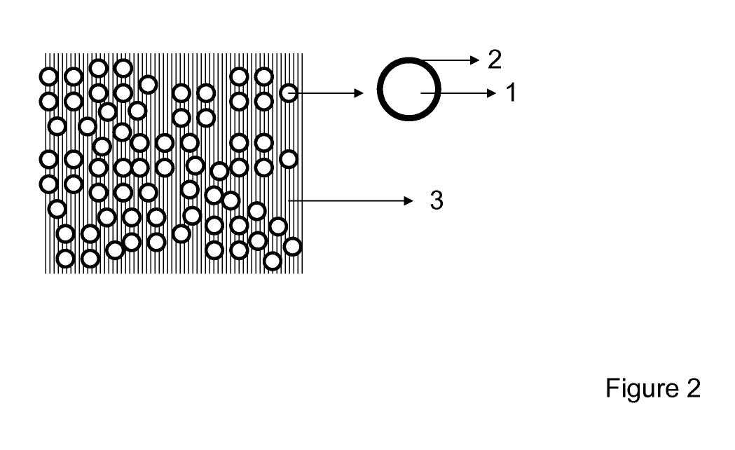

The nanoparticles of the present invention may comprise one or more polymer molecules. FIG. 2 shows a nanocomposite including polymer-stabilized nanoparticles dispersed in an inorganic phase. As shown, each nanoparticle includes a polymeric phase encapsulating an inorganic nanoparticle. The polymer can include natural polymers and/or synthetic polymers. The polymer can be homopolymers or copolymers of two or more monomers, including block copolymers and graft copolymers. Examples of polymers include materials derived from monomers such as styrene, vinyl pyrollidone, vinyl alcohol, vinyl naphthalene, vinyl acetate, styrene sulphonate, vinylnaphthalene sulphonate, acrylic acid, methacrylic acid, methylacrylate, acrylamide, methacrylamide, acrylates, methacrylates, acrylonitrile-alkyl acrylates (e.g. methyl, ethyl, propyl, butyl, hexyl, octyl, ethylhexyl, and the like) alkylmethacrylates, vinylacetate, vinylbutyrate, styrene, ethylene, propylene, alkyl acrylamide, dialkyl acrylamide, alkyl methacrylamide, dialkyl methacrylamide, and the like. Polysaccharide copolymers can comprise alkyl or alkoxycarbonylmethyl substituted monomers. Alternatively, chemical reactions affected on polymers to introduce functionality. Chemical reactions can include alkylation, esterification, amidation, UV decarbonylation, and the like.

In certain embodiments, the polymer can be partially hydrolyzed, as in the case of poly(vinyl alcohol). See, for examples, U.S. Pat. Nos. 7,501,180 and 7,534,490, the entire contents of both are herein incorporated by reference.

In some embodiments, the polymer includes a polyelectrolyte. A polyelectrolyte refers to a polymer that contains ionized or ionizable groups. The ionized or ionizable groups can be cationic or anionic. Examples of cationic groups include amino and quaternary ammonium groups, and examples of anionic groups include carboxylic acid, sulfonic acid and phosphates. The polyelectrolytes can be homopolymers, random polymers, alternate polymers, graft polymers, or block copolymers. The polyelectrolytes can be synthetic or naturally occurring. The polyelectrolytes can be linear, branched, hyper branched, or dendrimeric. Examples of cationic polymers include, but are not limited to, poly(allylamine hydrochloride) (PAAH), and poly(diallydimethylammonium chloride) (PDDA). Examples of anionic polymers include, but are not limited to, polyacrylic acid (PAA), poly(methacrylic acid), poly(sodium styrene sulfonate) (PSS), and poly(2-acrylamido-2-methyl-1-propane sulphonic acid) (PAMCS). In some embodiments, the polymer includes a biopolymer or modified biopolymer, such as carboxymethylcellulose, chitosan, agar, gelatin, proteins, polynucleic acids, alginate, and poly(lactic acid). Examples of copolymers include, but are not limited to poly(methylacrylate-co-ethylacetate) (P(MAA-co-EA)) and poly(methylacrylate-co-styrene). In some embodiments, the polymer (e.g., the polyelectrolyte) has a high molecular weight. For example, the molecular weight can be greater than or equal to approximately 50,000 D, greater than or equal to approximately 100,000 D, or greater than or equal to approximately 200,000 D. In certain embodiments, the molecular weight is less than 10,000 D. In certain embodiments, the polymer can be an oligomeric or polymeric ethylene glycol.

In some embodiments, the nanocomposite does not comprise a polymer. This can be effected by, e.g., forming the nanocomposite comprising an inorganic phase and nanoparticles encapsulated by polymers, and then subjecting the nanocomposite to increased temperature to pyrolyze or burn off the polymer.

As described below, the nanocomposite can be formed by dispersing nanoparticles in a suitable solvent, adding a precursor to an inorganic phase to the solvent where at least one component of the precursor associates with the nanoparticles, and modifying the one component of the inorganic precursor to form a nanocomposite.

One feature of the nanocomposite is that the secondary inorganic phase can provide the nanocomposite the ability to shape the nanocomposite into a desired shape. The nanocomposite can be shaped into granules, spheres, powders, extruded shapes, or any other desirable shape to facilitate a particular function and/or for ease of application. Nanocomposites having differently sized and shaped supports can be used in different reactor beds, including fixed bed reactors, slurry type reactors, and ebulliated bed reactors. Nanocomposites having differently sized and shaped supports can also be used in cartridge or column configurations, e.g. for contaminant removal from water. In some embodiments, the nanocomposite has an average particle size of from approximately 10 to approximately 100 nm. In some embodiments, the nanocomposite has an average particle size of from approximately 100 nm to approximately 1 micron. In some embodiments, the nanocomposite has an average particle size of from approximately 1 micron to approximately 100 microns. In some embodiments, the nanocomposite has an average particle size greater than 100 microns. In some embodiments, the nanocomposite has an average particle size less than 100 nm. In some embodiments, the nanocomposite has an average particle size greater than 1 micron. The nanocomposites can be used as aqueous suspensions or pastes to coat a surface.

The secondary, e.g., inorganic, phase can include (e.g. be formed of) any solid inorganic material capable of carrying the nanoparticles. Examples of materials that can be included in the inorganic phase include, but are not limited to, inorganic supports such as inorganic carbon (amorphous carbon, pyrolytic carbon, activated carbon, charcoal, ash, graphite, fullerenes, nanotubes or diamond), metal oxides (e.g. metal oxides such as titanium oxide, iron oxide, zirconium oxide, cerium oxide, magnesium oxide, silica, alumina, calcium oxide, aluminum oxide), metal carbonates (e.g. calcium carbonate, etc.), mixed metal oxides, metal hydroxides or oxyhydroxides or mixed metal hydroxides or oxyhydroxides, and salts (e.g. cadmium telluride, zinc sulfide). In certain embodiments, the inorganic phase is insoluble or has limited solubility in water.

In some embodiments, nanocomposites are prepared by forming a secondary phase in-situ with the nanoparticle. These composites benefit from direct electrostatic (salt cation-anion type), hydrogen-bonding, coordination, and complexation, polar-type interactions, to achieve intimate contact between the nanoparticle and the growing secondary phase. These interactions are of such strength to be maintained through the process of secondary phase formation. During formation of the secondary phase, the secondary phase does not entirely encapsulate the core nanoparticle. This is demonstrated by the fact that the core still has activity, e.g. with embodiments demonstrating catalytic activity or ion exchange.

In some embodiments, nanocomposites that are prepared by contacting nanoparticle and a pre-formed secondary phase and adding agents to reduce solubility of the nanoparticle in order to provoke interaction between the secondary phase and the nanoparticle. The principal interactions are coordination, electrostatic, hydrogen bonding, i.e., polar interactions, but hydrophobic, van der Waal type interactions may play a role in certain embodiments, such as when the secondary phase is graphitic carbon. In these cases, that the nanocomposite is relatively homogeneous and does not phase separate.

In some embodiments, nanocomposites are prepared by contacting an electrode with a nanoparticle solution (suspension) and applying an electric potential. Electrostatic, coordination, H-bonding, polar type interactions occur between the electrode and the nanoparticles, leading ultimately to a surface-coating type nanocomposite.

The primary interactions that promote interaction between nanoparticle and the secondary phase are those related to, but not limited exclusively to, direct electrostatic (salt cation-anion type), hydrogen-bonding, coordination, and complexation, polar-type interactions.

In certain embodiments, the inorganic phase of the nanocomposite is porous and contains the nanoparticles dispersed in the pores of the secondary phase. In certain embodiments, the presence of the nanoparticles imparts or induces porosity to the secondary (e.g., inorganic) phase during synthesis of the secondary phase; that is, inorganic secondary phase formed in the absence of the nanoparticles has a lower porosity than inorganic secondary phase formed in the presence of the nanoparticles.

In certain embodiments, the pores are in the range of the size of the nanoparticles which along with specific interactions between the nanoparticle and the inorganic phase, help to prevent the nanoparticles from diffusing throughout the inorganic phase, and hence the nanoparticles are resistant to agglomeration, aggregation, or sintering. In certain embodiments, the nanoparticles are uniformly dispersed throughout the secondary phase. In other embodiments, the nanoparticles are clustered in domains in the secondary phase. Loading throughout a secondary phase can be evaluated by performing a cross-sectional surface analysis such as x-ray photoelectron spectroscopy (“XPS”).

Alternatively, the porosity may provide for release of the nanoparticles under conditions favoring release. Thus, the secondary phase may serve as a delivery vehicle for the nanophase.

Alternatively, the porosity of the bulk secondary phase is selected to be of dimensions suitable for the support of cell growth.

The porosity of the nanocomposite can be measured using BET surface area analysis. In certain embodiments, the surface area of the nanocomposite is greater than approximately 300 m²/g, greater than approximately 200 m²/g, greater than approximately 150 m²/g, greater than approximately 100 m²/g, greater than approximately 50 m²/g, greater than approximately 25 m²/g, greater than approximately 1 m²/g. In certain embodiments, the surface area of the nanocomposite is between approximately 200 m²/g and approximately 300 m²/g. In certain embodiments, the surface area of the nanocomposite is between approximately 100 m²/g and approximately 200 m²/g. In certain embodiments, the surface area of the nanocomposite is between approximately 1 m²/g and approximately 100 m²/g.

The porosity of the nanocomposite provides fast kinetic transport of gases or solvent to the interior of the nanocomposite. The solvent can transport solvent-borne species into the nanocomposite in this fashion. These kinetics can be assayed by e.g. examining the uptake of a dye molecule into a nanocomposite that can capture the dye by ion exchange or sorbency.

The loading of the nanomaterials into or on the nanocomposite can be very high. In certain embodiments, the nanocomposite can comprise more than 30% nanoparticle by weight. In certain embodiments, the nanocomposite can comprise between 20 and 30% nanoparticle by weight. In certain embodiments, the nanocomposite can comprise between 10 and 20% nanoparticle by weight. In certain embodiments, the nanocomposite can comprise between 1 and 10% nanoparticle by weight. The nanophase loading can comprise both polymer and inorganic components (e.g., polymer-stabilized nanoparticles), and can include high loading of polymer. In some embodiments, the polymer loading in the nanoparticle is more than 80% by weight. In some embodiments, the polymer loading in the nanoparticle is between 50% and 80% by weight. In certain embodiments, the polymer loading in the nanoparticle is less than 50%.

In certain embodiments, the nanocomposite can have low density.

Synthesis

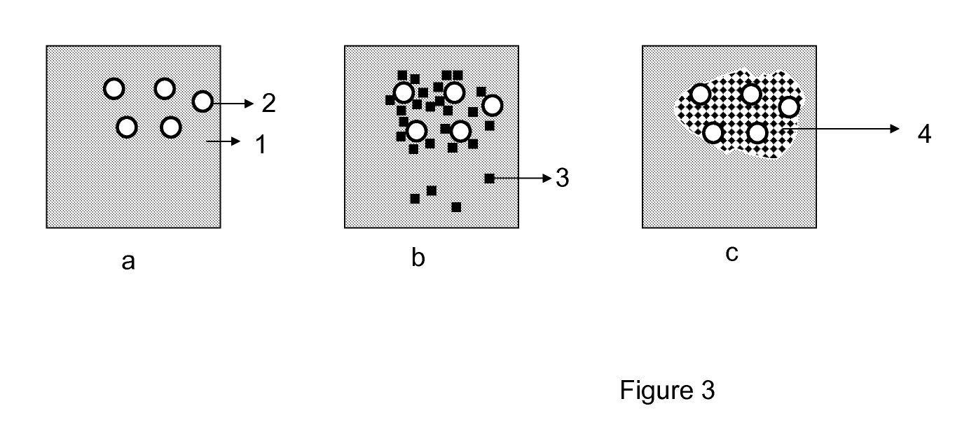

FIG. 3 shows a method of making the nanocomposite. This method can include the steps of (a) dispersing nanoparticles (1) in a suitable solvent (2); (b) adding at least one precursor component (3) which can lead to the formation of a secondary phase to the solvent; and (c) modifying the one precursor component of the secondary phase to form a nanocomposite (4). The modifying step (c) can comprise creating a solid secondary material phase wherein the nanophase component is substantially or partially entrapped, embedded or otherwise associated as part of a nanocomposite product. In some embodiments, the nanoparticles comprise a mineral phase (e.g., a polymer-stabilized nanoparticle). In certain embodiments, the polymer is a polyelectrolyte.

The solution containing the nanoparticles can be formed by dispersing nanoparticles in a solvent. The solvent can include any compositions capable of dispersing the nanoparticles. The term dispersion of the invention can include homogeneous and heterogeneous liquid states, wherein the nanoparticle can be deaggregated (as individual nanoparticles in solution), dispersed aggregates (aggregates of nanoparticles) and slurries (partially solvated aggregates). The solvent can include an organic solvent (e.g. alkanols, ketones, amines, dimethylsulfoxide, etc.,), and/or an inorganic solvent (e.g. water). The solvent can include two or more different compositions. Solvent selection may be based upon the nature of the nanoparticle, whether polymer-stabilized or not, comprising the nanophase. As examples, if the nanoparticle is encapsulated by a water-soluble polyelectrolyte, the nanoparticle can be dispersed in water. The water dispersibility is provided by the water-soluble polyelectrolyte, which has water solubility under appropriate conditions due to its ionizable groups. Alternately, if the nanoparticle is stabilized by a solvent-soluble species, the nanoparticle can be dispersed in the solvent that the stabilizer is soluble in.

Next, a precursor which can lead to the formation of a secondary phase (e.g., inorganic phase) is added to the solvent. “Precursor” refers to a compound or entity at least a portion of which is a component of the eventual nanocomposite formed. Examples of inorganic precursors include metal complexes (e.g. metal-ligand complexes or organometallic compounds), metal salts, inorganic ions, or combinations thereof. For example, the inorganic precursor can include an ion of an inorganic salt, such as one having the formula MₓA_{y}, where M is a Group I to IV metal cation possessing a +y charge, and A is the counter-ion to M with a −x charge, or a combination thereof. Specific examples include FeCl₂, FeCl₃, Ce(NO₃)₃, Al(NO₃)₃, Zn(NO₃)₂, CaCl₂, Na₂SiO₄, Ni(NO₃)₃, MgCl₂, CeNO₃. At least a portion of this precursor associates with the nanoparticles. In certain embodiments, the association between the precursor and the nanoparticle can occur due to charge-charge interactions. As an example, if the nanoparticle is stabilized by a polyelectrolyte, and solution conditions are such that the polyelectrolyte is at least partially charged, an oppositely charged inorganic ion will associate with the polyelectrolyte. In some embodiments, the association between the precursor and the nanoparticle can occur due to specific or non-specific chemical interactions. As an example, if the nanoparticle is stabilized by a thiol-containing species, and a gold precursor is added to the solution, the gold will associate with the nanoparticle.

In certain embodiments, the association between the precursor and the nanoparticle can occur via covalent bonding, ionic interactions, hydrogen bonding coordination, or complex formation. As described above, the nanocomposite resulting from the in-situ formation of a secondary phase in the presence of a nanoparticle, that the nanoparticle does not become entirely encapsulated which would have masked the intrinsic properties of the nanoparticle. For example, nanoparticles comprising TiO₂, Pt and Pd have catalytic properties even after combining with a secondary inorganic phase, such as Al₂O₃ and CeO₂. As another example, the polymer stabilizing the nanoparticle can participate in ion exchange, and therefore is accessible to the solution.

After a portion of the precursor associates with the nanoparticles (e.g., polymer-stabilized nanoparticles) in the nanophase, the portion of the precursor is modified to form a nanocomposite. In one embodiment, this modification step causes the precursor to the secondary phase to form an insoluble inorganic phase that precipitates out of solution. Under an appropriate choice of solution conditions, as the insoluble inorganic phase forms, it traps the nanoparticles the precursor is associated with inside the growing inorganic phase.

In certain embodiments, the nanoparticles have an affinity for the inorganic phase and are chemically or physically associated, or both, with it during growth. In certain embodiments, the nanoparticles may not have an affinity for the inorganic phase, but are trapped inside the inorganic phase due to kinetic barriers.

In other embodiments, a nanocomposite may be produced by contacting nanoparticles dispersed in a suitable solvent with a secondary inorganic phase followed by the addition of agents that promote interaction of the two phases and formation of the nanocomposite. This method can include steps of (a) dispersing nanoparticles in a suitable solvent; (b) adding an inorganic secondary phase to the dispersion; (c) adding an agent or combination of agents that promote interaction of the nanoparticles and the secondary phase; and (d) recovering the nanocomposite. Examples of materials that can be included in the secondary inorganic phase include, but are not limited to, inorganic materials such as inorganic carbon (amorphous carbon, pyrolytic carbon, activated carbon, charcoal, ash, graphite, fullerenes, nanotubes or diamond), metal oxides (e.g. metal oxides such as titanium oxide, iron oxide, zirconium oxide, cerium oxide, magnesium oxide, silica, alumina, calcium oxide, aluminum oxide), metal carbonates (e.g. calcium carbonate, etc.,.), mixed metal oxides, metal hydroxides or oxyhydroxides or mixed metal hydroxides or oxyhydroxides, and salts (e.g. cadmium telluride, zinc sulfide). Agents that promote interaction of the nanophase and the secondary inorganic phase can include any one or combination of: (a) water-miscible solvents or solvent mixtures, including but not limited to, tetrahydrofuran, dioxane, acetone, methyl ethylketone (MEK), propanol, ethanol or the like; (b) salts, include but are not limited to any one or mixtures of sodium, potassium, calcium, magnesium, lithium salts of common anions including chloride, bromide, sulfate, nitrate, carbonate and phosphate; (c) organic or mineral acid and base, including but not limited to acids such as acetic acid, proprionic acid, hydrochloric acid, sulfuric acid, phosphoric acid, and the like, as well as ammonium gas and hydroxide salts of any one or mixtures of ammonium, sodium, potassium, calcium, magnesium, lithium and (d) electric and electrostatic potential or electric current.

For example, in certain embodiments, the nanoparticles are polymer-stabilized nanomaterials, e.g. magnetite sodium polyacrylate polymer-stabilized nanoparticles, which are combined with a secondary phase, e.g. activated carbon, and the agent to promote interaction of the two phases is the water-miscible organic solvent, e.g. methyl-ethylketone. The resultant nanocomposite has the properties of activated carbon, e.g. sorption of hydrophobic substances, and is magnetic which allows the separation of the nanocomposite from solution with an external magnet.

In other embodiments, nanoparticles dispersed in a solvent are placed in contact with an electrode. Application of an electric potential causes adsorption of the nanoparticles on the surface of the electrode creating a nanocomposite.

In other embodiments, a modification step can include heating the precursor to a temperature high enough to cause modification of the precursor i.e. decomposition of the precursor to its component parts or pyrolysis. In certain embodiments, the heating process takes place under an inert atmosphere or at elevated pressures. In some embodiments, the modification step can be a reduction, oxidization, or reaction step (e.g. by precipitation with an external agent). For example, if the precursor to the inorganic phase is a suitable metal ion, addition of a carbonate counter-ion can result in the formation of an insoluble metal carbonate that traps the nanoparticles inside as it grows. In some embodiments, the modification can include changing the pH of the solution, to cause, e.g. hydrolysis of the precursor. The pH is chosen to effect decomposition or hydrolysis of the precursor to form the inorganic phase. In other embodiments, a pH change can be used to effect the formation of an insoluble hydroxide, oxide, or oxyhydroxide. In some embodiments, the modification step also modifies the nanophase as well.

Functionality of the Composite

The nanocomposite of the present invention comprises at least two components. It comprises an inorganic phase that can be chosen to provide a first functionality to the nanocomposite. It also comprises a nanoparticle that can provide a second functionality to the nanocomposite. In some embodiments, the functionality provided by each component can be the same or a different functionality to the composite. The nanoparticle can further include a polymer which can also provide functionality to the composite. The nanocomposite therefore can have the combination of the functions provided by the inorganic phase, the nanoparticle, and (optionally) the polymer, and hence be multifunctional. These functions can be independent of the other components of the system, or could be synergistic or antagonistic to the other components of the system i.e., the functionality provided by one component of the nanocomposite need not be related, complementary, or determinative of the functionality provided by the other component(s) in the nanocomposite. The multifunctionality can be further increased by incorporation of multiple types of nanoparticles that either differ in their polymer or inorganic type.

The function provided by the secondary, or inorganic, phase can include, but is not limited to, catalysis, physical or chemical absorption of vapor- or solvent-borne species, susceptibility to magnetization, light absorption, photocatalysis, structural reinforcement, gas storage, and stability to UV or heat.

As discussed previously, the nanoparticle can include an inorganic component. This inorganic component can provide magnetization, physical or chemical absorption of vapor- or solvent-borne species, catalysis, photocatalysis, antimicrobial, fluorescence, light absorption or emission, gas storage, anti-fouling, or porosity imparted to the composite.

Under certain conditions, the inorganic phase can be facile for a vapor- or solvent-borne species to diffuse to the nanoparticle surface. Examples of suitable conditions include the nanocomposite being highly porous. In this case, the nanoparticles can provide highly effective catalysis. As an example, the nanoparticles can provide photocatalysis to the composite. In this specification, ‘photocatalysis’ is understood to mean a chemical reaction that requires the presence of light mediated by an inorganic species (the “photocatalysis”), such as inorganic semiconductors. In some embodiments, where breakdown of organics is desired, photocatalysis is understood to encompass all forms of photodegradation of the organics that are accelerated, enabled, or enhanced by the presence of the photocatalyst. Many photocatalysts are not effective in visible light. It is possible to enhance the photocatalytic activity of a semiconductor photocatalyst by including one or more dopants. As seen in the example, incorporation of a photocatalyst nanoparticle into the nanocomposite can provide the function of photocatalysis to the composite.

Another example of catalysis is an oxidation catalyst. Oxidation catalysts accelerate the oxidation of chemical species and find application as e.g. catalytic converters, self-cleaning systems, and in industrial chemistry. The examples demonstrate the use of nanocomposites containing a nanoparticle providing the function of oxidation catalyst. In certain embodiments, the nanocomposite with the function of oxidation catalyst can be enhanced by incorporation of other chemical species into the composite. As an example, if the nanoparticle is an oxidation catalyst such as Pd, its efficiency can be enhanced under certain conditions by using an inorganic phase of cerium oxide in the composite. The cerium oxide can provide oxygen storage and absorption to allow for catalytic activity under low-oxygen content conditions. In certain embodiments, the nanocomposite with the function of oxidation catalysis can effectively catalyze oxidation of carbon monoxide below 60 degrees C. In certain embodiments, the nanocomposite with the function of oxidation catalysis can effectively catalyze oxidation of carbon monoxide below 100 degrees C.

In certain embodiments, the nanoparticle may comprise a polymer (e.g., a polymer-stabilized nanoparticle). This polymer can also provide additional functionality, including physical or chemical absorption of species from vapor or solution. In one embodiment, the polymer is a polyelectrolyte that is capable of ion exchange. When a nanocomposite containing polyelectrolyte-stabilized nanoparticles is put in contact with a solution containing ions of opposite charge to the polyelectrolyte, ion exchange can take place. The efficiency of ion exchange can be modified in a number of ways, including by not limited to choosing a polyelectrolyte with selectivity for the ions of interest, or providing a nanocomposite that has fast kinetic exchange of ions from the solution to the interior of the nanocomposite (e.g. by having high porosity). Depending on the charge of the polyelectrolyte, ions of differing charge can be captured.

The capacity of the nanocomposite for ion exchange is dependent on, among other things, the porosity of the composite, the loading of the polymer in the nanocomposite the charge density of the polymer, and whether any of the charged groups in the polymer are chemically bound to the inorganic phase of the nanocomposite or the inorganic component of the nanoparticle. The proportion of monomer groups available for exchange can be measured by measuring the mole ratio of absorbed monovalent ions to monomer units. In certain embodiments, more than 30% of the monomer groups in the polymer are available for ion exchange. In certain embodiments, more than 50% of the monomer groups in the polymer are available for ion exchange. In certain embodiments, more than 70% of the monomer groups in the polymer are available for ion exchange. In certain embodiments, the capacity of the nanocomposite for ion exchange is more than 300 g contaminant/kg composite. In certain embodiments, the capacity of the nanocomposite is between 200 g contaminant/kg composite and 300 g contaminant/kg composite. In certain embodiments, the capacity of the nanocomposite is between 100 g contaminant/kg composite and 200 g contaminant/kg composite. In certain embodiments, the capacity of the composite is between 10 g contaminant/kg composite and 100 g contaminant/kg composite.

Combinations of the properties for each component of the nanocomposite can be useful in specific applications. As an example, iron oxides are known to have a high affinity for arsenic-containing species such as arsenite and arsenate. Removal of arsenite and arsenate is a challenge for ion exchange systems, but ion exchange is a very useful technique for removal of heavy metals from drinking water streams. A multifunctional nanocomposite prepared according to the present invention including an inorganic phase of magnetite providing arsenic absorption and a nanoparticle including an anionic polymer providing heavy metal absorption and an inorganic nanoparticle providing porosity to the nanocomposite can be used to remove arsenic and heavy metals from water.

When the nanocomposite of the present invention is used as an ion exchange system it can be regenerated using standard techniques, such as using a brine wash. By using a brine wash, the absorbed species from solution can be removed from the composite. The then absorbed species may be either used or disposed of.

In certain embodiments, the nanocomposite can be used for physi-sorption of organic substances. For example, the nanophase of the nanocomposite can have an affinity for hydrophobic substances. Sorption can occur by hydrophobic interaction with nanophases comprising copolymers composed of hydrophobic monomers.

In other embodiments, the secondary phase of the nanocomposite can be useful for sorption. For example, magnetic nanoparticles comprised of Fe2O3 can be combined with activated carbon and the resulting nanocomposite can used to adsorb hydrophobic impurities from solution, e.g. oil from water. The same nanocomposite can then be separated from the solution using a magnet.

In other embodiments, the nanoparticle of a nanocomposite can have sorption capacity for organic substances in solution, e.g. dyes.

In certain embodiments, the secondary phase can be capable of being separated magnetically from solution. As an example, if the secondary phase is magnetite, and the nanoparticles are polyelectrolyte-encapsulated nanoparticles that participate in ion exchange, the resulting nanocomposite can participate in ion exchange and be magnetically separated from solution using a laboratory magnet. The resulting nanocomposite is a multifunctional, magnetically susceptible ion exchange resin. Similarly, magnetically susceptible secondary phases can be used to make magnetically separable catalysts where the nanoparticle component provides catalytic function to the composite.

The secondary phase can also help to prevent sintering of the nanoparticles at elevated temperatures. Prevention of sintering is desirable for catalysis, as sintered nanoparticles typically have lower catalytic activity. If the nanoparticles are embedded into a porous nanocomposite where the pores are sufficiently small as to prevent the nanoparticles from moving throughout the composite, then the nanoparticles will be resistant to sintering even under elevated temperatures. In this case, the secondary phase provides porosity and resistance to sintering for the catalytic nanoparticles. In another embodiment, if the nanoparticle catalyst is polymer-stabilized, and the polymer has an affinity for the secondary phase, the polymer stabilizer can keep the nanoparticles ‘anchored’ to the surface, even under elevated temperatures up to temperatures where the polymer will burn or be otherwise degraded.

### EXAMPLES

Preparation of inorganic/polymer nanoparticles. In the below, the nomenclature ‘MₓN_{y}/PAA would refer to an inorganic nanoparticle with the structure MₓN_{y} stabilized by the polymer poly(acrylic acid) (PAA).

### Example 1

### N-doped-TiO₂/PAA

100 mL of polyacrylic acid (PAA) solution (450K MW, 2 mg/mL in water, pH 6.8 with 5% by weight 1800 MW PAA) was mixed with 200 mL deionized water and stirred vigorously. 500 μL TALH (Titanium(IV) bis(ammonium lactato)dihydroxide 50 wt. % solution in water) and 6.23 mg urea were mixed in 100 mL water. This solution was then added dropwise to the PAA solution under vigorous stirring. The resulting solution was then irradiated under (4) 254 nm UV germicidal lamps (USHIO G25T8) for 4 hours until the solution was filterable through a 0.2 μm syringe filter. The pH of the solution was adjusted to 10 by adding 0.5 M NaOH and was stirred at room temperature for 1 hour. After stirring, the solution was concentrated with a rotary evaporator (rotovap) to about 80 mL and was freeze dried. The freeze dried solid was then heated in a furnace (3 hours, N₂ atmosphere, 270° C.). Dynamic light scattering of the solution prior to freeze drying showed the presence of particles <10 nm in size. 40 mg of the resulting N—TiO₂/PAA was dissolved in 50 mL water. 0.15 mg of Methylene blue dye was added to the solution and was mixed well. The mixture was irradiated under a compact fluorescent lamp (Mini Spiral Lamp Fluorescent Bulb(GE-FLE26HT3/2/D), Helical 26 W, 120 VAC, 60 Hz, 390 mAmps, Daylight 6500K, 1600 lumens) for 1.5 hours. At least 90% of the methylene blue was decolorized after 1.5 hours.

### Example 2

### Fe₃O₄/PAA

FeCl₂ (0.350 g) and FeCl₃.6H₂O (1.455 g) were dissolved in 250 mL of deoxygenated water under nitrogen atmosphere resulting in a yellow colored solution. This mixture was added to 375 mL of vigorously stirred PAA solution (450K MW, 2 mg/mL in water, pH 6.8 with 5% by weight 1800 MW PAA). To initiate Iron oxide formation, 1 M NaOH was added drop-wise with vigorous stirring under nitrogen atmosphere until the color of the solution turned black. The resulting solution was stirred vigorously under nitrogen atmosphere for 30 min. The solution was then heated to 80° C. and was left at this temperature for an hour to promote crystalline maturation. The solution was then irradiated with UV under (4) 254 nm UV germicidal lamps (USHIO G25T8) until they were filterable using a 0.2 um syringe filter. Dynamic light scattering on the solution showed the presence of particles <10 nm in size. The nanoparticles were precipitated by adding 30 mL 3M NaCl and 700 mL absolute (100%) ethanol. The isolated solid was then washed 3 times with 70% ethanol, and was then redispersed in 300 mL deionized water. The solution was then freeze-dried. Superconducting Quantum Interference (“SQUID”) magnetometer measurements on the Fe₃O₄/PAA nanoparticles indicate superparamagnetic behavior from 10-300 K. Blocking temperature was observed at 100 K.

### Example 3

### Fe₂O₃/PAA

100 mL of 0.93 mM FeCl₃ solution was prepared by dissolving 25.12 mg of FeCl₃.6 H₂O in 8 mL 1 M HCl and adding 92 mL of deionized water. 100 mL PAA solution (450K MW, 2 mg/mL in water, pH 6.8 with 5% by weight 1800 MW PAA) was diluted with 100 mL of deionized water and stirred vigorously. The FeCl₃ solution was then added to the PAA solution drop wise at the rate of 1 mL/min. The solution was irradiated under (4) 254 nm UV germicidal lamps (USHIO G25T8) until it was filterable through a 0.2 μm filter. The pH of the resulting solution was adjusted to 10 by adding 1 M NaOH, and was stirred at room temperature for 30 mins. Dynamic light scattering on the solution showed the presence of particles <10 nm in size. The nanoparticles were precipitated by adding 15 mL 3M NaCl and 500 mL absolute (100%) ethanol. The isolated solid was then washed 3 times with 70% ethanol, and was then redispersed in 300 mL deionized water. The solution was then freeze-dried. SQUID measurements on the Fe₂O₃/PAA nanoparticles showed superparamagnetic behavior and a Blocking temperature of 30K.

### Example 4

### Au/PAA

250 mL of polyacrylic acid (PAA) solution was prepared (450K MW, 1 mg/mL in water, pH 6.8 with 5% by weight 1800 MW PAA). 125 mL 0.93 mM HAuCl₄ solution by dissolving 39.5 mg of HAuCl₄ in 125 mL of deionized water. HAuCl₄ solution was added to a vigorously stirred PAA solution at the rate of 2 mL/min. Once all of the HAuCl₄ solution has been added stirring was continued at room temperature for 30 mins. 40.6 mg of NaBH₄ was added to the solution in one lot while the solution was being stirred. The solution turned a deep red color. The solution was then irradiated under (4) 254 nm UV germicidal lamps (USHIO G25T8) until it was filterable through a 0.2 μm filter. Dynamic light scattering on the solution showed the presence of particles <10 nm in size. The solution was precipitated by adding 15 mL 3M NaCl and 500 mL absolute (100%) ethanol. The isolated solid was then washed 3 times with 70% ethanol, and was then redispersed in 300 mL deionized water. The solution was then freeze-dried. A distinct UV-visible Au Plasmon band was observed at ˜520 nm.

### Example 5

### Pd/PAA

PdCl₂ (22.5 mg) was dissolved in a mixture of DI water (10 mL) and HCl (1M, 0.5 mL). The mixture was vigorously stirred until it became a clear solution which was diluted to make a total volume of ˜25 mL. The pH was adjusted to ˜6.4 with NaOH (1M). The solution of PdCl₂ was added dropwise to a vigorously stirred solution of PAA (450K MW, 2 mg/mL in water, pH 6.8 with 5% by weight 1800 MW PAA) and DI water (18.75 mL) at a rate of 1 ml/min. NaBH₄(40 mg) was added to the vigorously stirred solution. The solution was stirred for 2 h at room temperature. The resulting solution was irradiated under (4) 254 nm UV germicidal lamps (USHIO G25T8) until it was filterable through a 0.2 μm filter. Dynamic light scattering on the solution showed the presence of particles <10 nm in size. The solution was precipitated by adding 15 mL 3M NaCl and 500 mL absolute (100%) ethanol. The isolated solid was then washed 3 times with 70% ethanol, and was then redispersed in 300 mL deionized water. The solution was then freeze-dried. Powder X-ray diffraction measurements confirm the presence of Pd nanoparticles.

### Example 6

### Pt/PAA

66 mg of H₂PtCl₆ was dissolved in 25 mL of deionized water. 25 mL of PAA solution (450K MW, 2 mg/mL in water, pH 6.8 with 5% by weight 1800 MW PAA) was mixed with 25 mL of deionized water and stirred vigorously. The platinum solution was added into the vigorously stirred solution of PAA dropwise at the rate of 2 mL/min. Once all the Pt solution was added, the solution was stirred for 30 mins at room temperature. 20 mg NaBH₄ was added into the vigorously stirred solution. The color of the solution turned black. This solution was stirred at room temperature for 30 min. The resulting solution was irradiated under (4) 254 nm UV germicidal lamps (USHIO G25T8) until it was filterable through a 0.2 μm filter. Dynamic light scattering on the solution showed the presence of particles <10 nm in size. The solution was precipitated by adding 15 mL 3M NaCl and 500 mL absolute (100%) ethanol. The isolated solid was then washed 3 times with 70% ethanol, and was then redispersed in 300 mL deionized water. The solution was then freeze-dried. Powder X-ray diffraction measurements confirm the presence of Pt nanoparticles.

### Example 7

### Bi₂O₃/PSS

0.0724 grams (0.149 mmole) of bismuth nitrate was dissolved in 2 ml concentrated 70% nitric acid (15.6M), and was diluted to 100 ml with deionized water. This bismuth nitrate solution was added dropwise under constant stirring to 200 ml polystyrenesulfonic acid (PSS) solution (2 mg/mL PSS M_{w}=1,000,000, with 5% 1800 MW PAA added). The resulting solution was then irradiated with under (4) 254 nm UV germicidal lamps (USHIO G25T8) until it was filterable through a 0.2 μm filter. The color of the solution changed from colorless to yellow. pH of the solution was adjusted to 8 with 10M sodium hydroxide solution. After pH adjustment, the color of the solution changed to deep orange. This solution was heated to 70° C. and was stirred for 2 hours (at 70° C.). Dynamic light scattering on the solution showed the presence of particles <10 nm in size. The solution was concentrated to 50 ml using a rotary evaporator, and was precipitated by adding 2 mL 3M NaCl and 100 mL absolute (100%) ethanol. The isolated solid was then washed 3 times with 70% ethanol, was then redispersed in 100 mL deionized water, and was freeze dried. The color of the freeze dried solid was orange-brown. The solid was then heated in a glass furnace under vacuum at 400° C. for 2 hours. The final color of the solid was dark brown.

### Example 8

### Al(OH)₃/PAA

2.64 L of 0.1M NaOH solution was added slowly to 6 L 22 mM Al(NO₃)₃ solution under vigorous stirring conditions. The pH changed slightly from 3.30 to 3.96. The Al(NO₃)₃ solution was slowly (10 mL/min) fed to a 6 L PAA solution (450K MW, 2 mg/mL in water, pH 6.8 with 5% by weight 1800 MW PAA added) while controlling of pH 7 by adding 100 mM NaOH solution (˜0.3 L). Once all of the Al(NO₃)₃ was added, the solution was sonicated for 10 mins under a probe sonicator (VirSonic) with 60% power. The solution was then irradiated under (4) 254 nm UV germicidal lamps (USHIO G25T8) under constant stirring. The pH of the resulting solution was adjusted to 8.5 with 3 M NaOH. Dynamic light scattering on the solution showed the presence of particles <40 nm in size. The solution was concentrated by 5-7× by using rotavap under temperature of 50° C. to a final volume of ˜1 L. The concentrated solution was precipitated by adding 50 mL 3M NaCl and 1 L absolute (100%) ethanol. Solid was isolated by centrifugation. The isolated solid was then washed 3 times with 70% ethanol. The washed solid was then redispersed in 2 L water and Freeze-dried.

### Example 9

### CeO₂/PAA

200 mL of 2.1 mM Ce(NO₃)₃ solution was added to a 200 ml PAA solution (450K MW, 2 mg/mL in water, pH 6.8 with 5% by weight 1800 MW PAA) dropwise with constant stirring. The resulting solution was clear. The solution was then irradiated under (4) 254 nm UV germicidal lamps (USHIO G25T8) until it was filterable through a 0.2 pm filter. 150 μL of 30% H₂O₂ was added to the solution which was stirred well. 10 ml of 0.2 M NaOH was added dropwise. The color of the solution turned bright yellow and was stirred for 30 mins. The solution was precipitated by adding 20 mL 3M NaCl and 100 mL absolute (100%) ethanol. The isolated solid was then washed 3 times with 70% ethanol, and was then redispersed in 300 mL deionized water. The solution was then freeze-dried. Dynamic light scattering on the solution prior to freeze drying showed the presence of particles <10 nm in size. Powder X-ray diffraction measurements confirm the presence of CeO₂ nanoparticles.

### Example 10

### BiVO₄/PAA

500 mL of 1.5 mM Bi(NO₃)₃ was prepared by dissolving 0.364 g Bi(NO₃)₃.5H₂O in 500 mL deionized water along with 2 mL 15.8M HNO₃. This solution was added dropwise into 500 mL PAA solution (450K MW, 2 mg/mL in water, pH 6.8 with 5% by weight 1800 MW PAA) under vigorous stirring and constant pH of 7.5. After addition, the resulting solution pH was about 7.9 after adjustment with 1 M NaOH or 1M HNO₃ as needed. The solution was then irradiated under (4) 254 nm UV germicidal lamps (USHIO G25T8) until it was filterable through a 0.2 μm filter. BiVO₄ was made by adding 20 mM NaVO₄ solution (0.136 g NaVO₄ in 20 ml deionized water). The solution was stirred at room temperature for 30 mins. Dynamic light scattering on the solution showed the presence of particles <10 nm in size. The solution was precipitated by adding 50 mL 3M NaCl and 1000 mL absolute (100%) ethanol. The isolated solid was then washed 3 times with 70% ethanol, and was then redispersed in 300 mL deionized water. The solution was then freeze-dried. Powder X-ray diffraction measurements confirm the presence of BiVO₄ nanoparticles.

### Example 11

### CdTe/PAA

500 mL of Cd(NO3)2 solution (3 mM) was added dropwise to 500 mL aqueous polyacrylic acid solution (1,200K MW, 2 mg/mL in water, pH 6.8 with 5% by weight 1800 MW PAA) under vigorous stirring (total 1 L). The solution was then irradiated under (4) 254 nm UV germicidal lamps (USHIO G25T8) until it was filterable through a 0.2 μm filter. CdTe was synthesized by adding 25 ml Na₂TeO₃ (10 mM), 1 g solid sodium borohydride, and 1 g solid trisodium citrate to the Cd/Polyacrylic acid solution. The resulting solution was then refluxed for 4 hours. After reflux, the solution was allowed to cool to room temperature. 0.700 mL of thioacetamide solution (100 mM) was then added and the solution was stirred and heated to 50° C. for another 18 hours. The addition of the thioacetamide makes the nanoparticles more stable to ambient conditions. Without the addition of thioacetamide, the CdTe lose their fluorescence within 48 hours. Dynamic light scattering measurements done on the solution showed the presence of particles <10 nm in size. The solid carboxylate capped CdTe was obtained by adding 50 mL NaCl (3M) and 2000 ml of absolute (100%) ethanol to the 1 L solution. After a few minutes of stirring, solid CdTe precipitated from solution. The solid was then isolated via centrifugation and was washed with 70% ethanol 3 times. The isolated solid was air dried and then stored in a dessicator before use. Powder X-ray diffraction measurements confirm the presence of CdTe nanoparticles. Emission at 530 nm is observed when the CdTe/PAA solution is irradiated with 360 nm light.

### Example 12

### Au/PDDA

67 mL of HAuCl₄ solution containing 5.498×10⁻⁵ moles of Au³⁺ was added dropwise at a rate of 10 mL/min to 133 mL of poly(diallyldimethylammonium chloride) solution (PDDA) (400-500K MW, 1 mg/mL, with 5% 60K MW poly(allylamine) added). After mixing, the solution was stirred at room temperature for 30 mins. 9.6 mg of NaBH₄ was added quickly under vigorous stirring, and the solution turned a deep orange/brown color. The solution was then irradiated under (4) 254 nm UV germicidal lamps (USHIO G25T8) until it is filterable through a 0.2 micron syringe filter. Dynamic light scattering measurements done on the nanoparticles prior to freeze drying indicated the presence of particles <10 nm in size. The solution was then freeze dried. Powder X-ray diffraction measurements confirm the presence of Au nanoparticles. UV-visible spectroscopy shows a distinct Au plasmon absorbance at ˜518 nm.

### Example 13

### ZnO/PAA

100 ml of 4 mM Zn(NO₃)₂ solution was added to 100 ml of PAA solution (1,200K MW, 2 mg/mL in water, pH 6.8 with 5% by weight 1800 MW PAA added) dropwise at a rate of ˜10 ml/min. After mixing, the solution was allowed to stir at room temperature for 30 mins, and then was irradiated under (4) 254 nm UV germicidal lamps (USHIO G25T8) until it was filterable through a 0.2 micron syringe filter. The solution was then heated to 80° C. and 10 mL of 10 mM NaOH was added. Dynamic light scattering measurements done on the nanoparticles prior to freeze drying indicated the presence of particles <10 nm in size. The solution was kept at 80° C. for 1 hour under constant stirring. The solution was then freeze dried. UV-vis spectra of the solutions show a strong absorbance at 300 nm. Powder X-ray diffraction measurements confirm the presence of ZnO nanoparticles.

### Example 14

### Bi₂O₃/PAA

200 mL PAA solution (450K MW, 2 mg/mL in water, pH 6.8 with 5% by weight 1800 MW PAA) was mixed with 200 mL Bi(NO₃)₃ solution (1.5 mM in 0.2M HNO₃) dropwise. During addition the pH of the PAA solution was maintained at 10 with the addition of 1M NaOH. After all the Bi(NO₃)₃ solution has been added, the resulting solution was stirred for an additional 30 minutes at room temperature. The solution was irradiated under (4) 254 nm UV germicidal lamps (USHIO G25T8) until it was filterable through a 0.2 micron syringe filter. The solution was then freeze dried and the freeze dried solid was heated in a furnace for 3 hours (N₂ flow, 270° C.).

Synthesis of Nanocomposites

The below nomenclature uses the same inorganic/polymer nomenclature as previously for the nanophase, and denotes the secondary component as |MₓN_{y}

### Example 15

### Bi₂O₃/PSS|Fe₃O₄

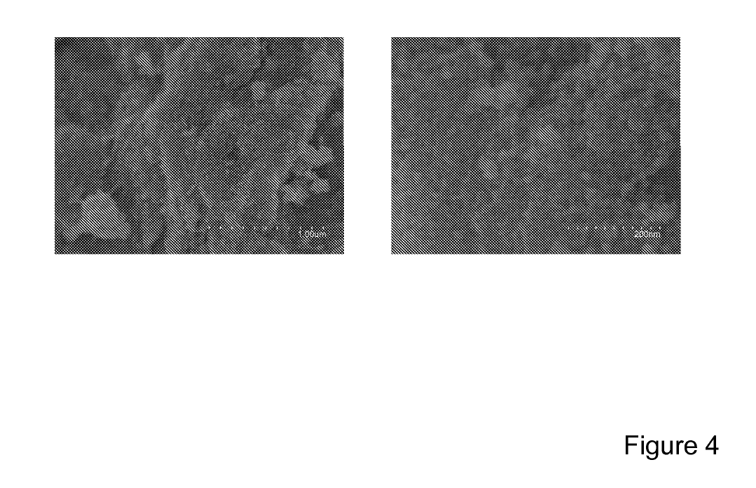

Bi₂O₃/PSS nanoparticles were made as described above. 684 mg of freeze-dried Bi₂O₃/PSS was dissolved in 250 mL deionized water. 1.25 g of FeCl₃ and 0.347 g of FeCl₂ was dissolved in 50 mL deionized water. The resulting Fe²⁺/Fe³⁺ solution was then added dropwise to the Bi₂O₃/PSS solution. The pH of the resulting solution was adjusted to 10 with 1M NaOH and then was stirred for ˜30 mins at room temperature. The black solid that precipitated was isolated by centrifugation, was washed 4 times with deionized water and was then dried in a vacuum oven. BET isotherm measurements on the dried solid gave a surface area of 228 m²/g. A certain amount of this material was mixed with either sodium arsenate (As (V)) or Co (II) solution. 8 g of material was capable of removing 54 mg As (V) species from solution. 9 g of material was able to remove 389 mg Co (II) species from solution. This material can be magnetically separated from solution. Representative FESEM images are shown in FIG. 4.

### Example 16

### Au/PAA|Fe₃O₄

Au/PAA nanoparticles were made according to the above example. 324 mg of freeze dried Au/PAA nanoparticles was completely dissolved n 125 mL deionized water. 625 mg of FeCl₃ and 173 mg of FeCl₂ was dissolved in 25 mL deionized water. The pH of the Fe²⁺/Fe³⁺ solution was adjusted to 3 with 1 M NaOH solution. The Au/PAA solution was then added dropwise. The pH of the resulting solution was adjusted to 10 with 1M NaOH and then was stirred for ˜30 mins at room temperature. The black solids that formed were isolated by centrifugation, washed 4 times with deionized water and then dried in a vacuum oven. BET isotherm measurements on the dried solid gave a surface area of 231 m²/g. A certain amount of this material was mixed with either As(V) or Co (II) solution. 8 g of material was able to remove 20 mg of As (V) species from solution and 9 g was able to remove 200 mg Co (II) from solution. This material can be magnetically separated from solution.

### Example 17

### TiO₂/PAA|Fe₃O₄

TiO₂/PAA nanoparticles were made according to the procedure described above. 324 mg of freeze dried TiO₂/PAA nanoparticles was completely dissolved in 125 mL deionized water. 625 mg of FeCl₃ and 173 mg of FeCl₂ was dissolved in 25 mL deionized water. The pH of the Fe²⁺/Fe³⁺ solution was adjusted to 3 with 1 M NaOH solution. The TiO₂/PAA solution was then added dropwise. The pH of the resulting solution was adjusted to 10 with 1M NaOH and then was stirred for ˜30 mins at room temperature. The black solids that formed were isolated by centrifugation, washed 4 times with deionized water and then dried in a vacuum oven. This material can be magnetically separated from solution. BET isotherm measurements on the dried solid gave a surface area of 8 m²/g.

### Example 18

### Fe₃O₄/PAA|Fe₃O₄

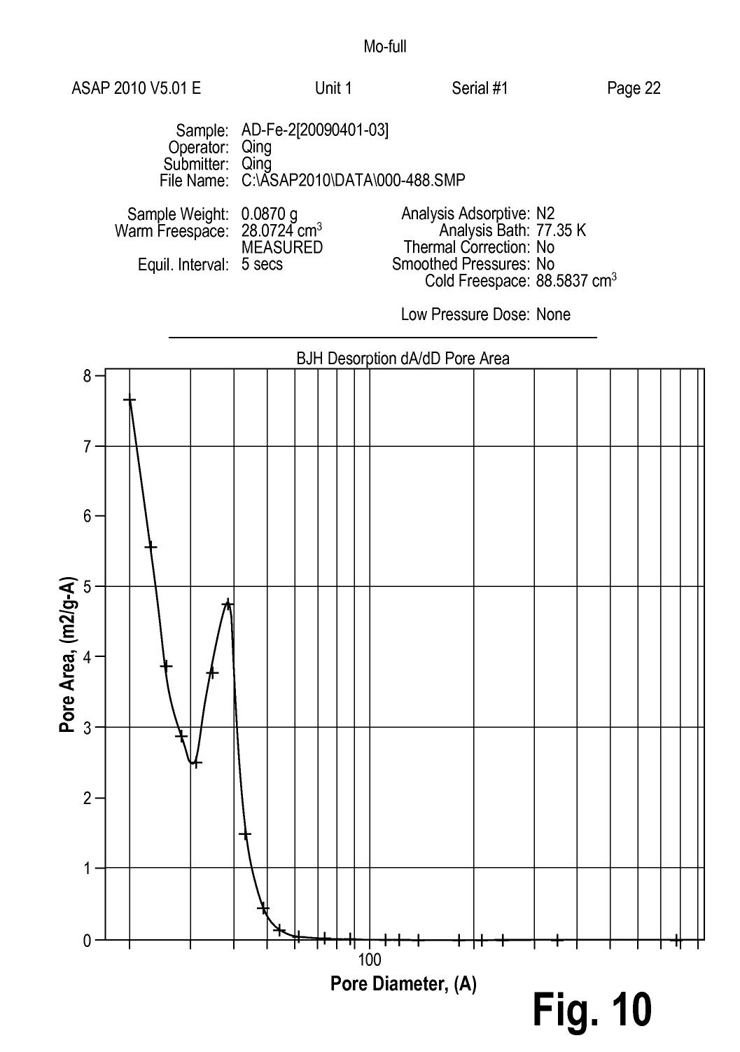

Fe₃O₄/PAA nanoparticles were made according to the procedure described above. 324 mg of freeze dried Fe₃O₄/PAA nanoparticles was completely dissolved in 125 mL deionized water. 625 mg of FeCl₃ and 173 mg of FeCl₂ was dissolved in 25 mL deionized water. The pH of the Fe²⁺/Fe³⁺ solution was adjusted to 3 with 1 M NaOH solution. The Fe₂O₃/PAA solution was then added dropwise. The pH of the resulting solution was adjusted to 10 with 1M NaOH and then was stirred for ˜30 mins at room temperature. The black solids that formed were isolated by centrifugation, washed 4 times with deionized water and then air dried A certain amount of this material was mixed with Co (II) solution. 9 g of this material can remove 600 mg of Co (II) from solution. This material can be magnetically separated from solution. The results of pore size determination from BET analysis (N2 sorption) is shown in FIG. 10 and shows that pores in the composite are essentially below 50 nm.

### Example 19

### Fe₃O₄/PAA|Fe₃O₄|PAAH

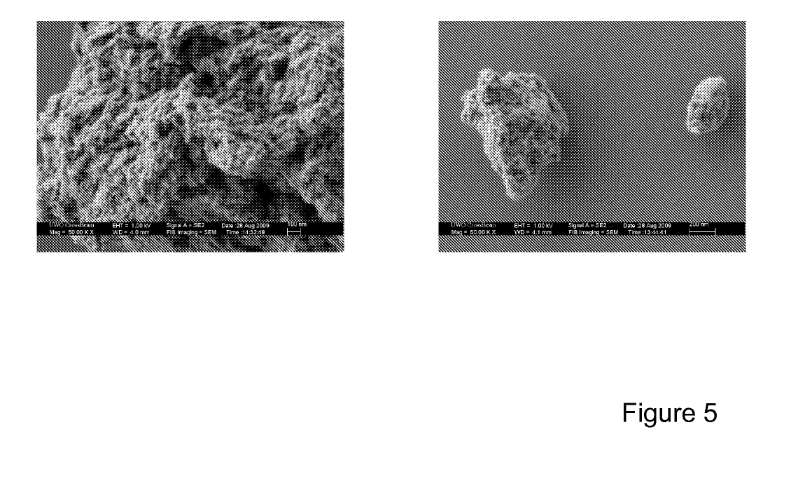

Fe₃O₄/PAA nanoparticles were made according to the procedure described above. 324 mg of freeze dried Fe₃O₄/PAA nanoparticles was completely dissolved in 125 mL deionized water. 625 mg of FeCl₃ and 173 mg of FeCl₂ was dissolved in 25 mL deionized water. The pH of the Fe²⁺/Fe³⁺ solution was adjusted to 3 with 1 M NaOH solution. The Fe₂O₃/PAA solution was then added dropwise. The pH of the resulting solution was adjusted to 10 with 1M NaOH and then was stirred for ˜30 mins at room temperature. The black solids that formed were isolated by centrifugation, washed 4 times with deionized water and then air dried. The air dried sample was then immersed in 100 mL of poly(allyamine hydrochloride) (PAAH) solution (5 mg/ml, pH 6.8) and was agitated on an orbital shaker for 30 mins at 250 rpm. The solid was then washed 4 times with deionized water, and isolated either by decanting or centrifugation. The washed isolated solid was then dried in a vacuum oven. A certain amount of this material was mixed with Co (II) solution. 9 g of material was able to remove 500 mg Co (II) species from solution. This material can be magnetically separated from solution. Representative FESEM images of the material are shown in FIG. 5.

### Example 20

### ZnO/PAA|Fe₃O₄

ZnO/PAA nanoparticles were made according to the procedure described above. 324 mg of freeze dried ZnO/PAA nanoparticles was completely dissolved in 125 mL deionized water. 625 mg of FeCl₃ and 173 mg of FeCl₂ was dissolved in 25 mL deionized water. The pH of the Fe²⁺/Fe³⁺ solution was adjusted to 3 with 1 M NaOH solution. The ZnO/PAA solution was then added dropwise. The pH of the resulting solution was adjusted to 10 with 1M NaOH and then was stirred for ˜30 mins at room temperature. The black solids that formed were isolated by centrifugation, washed 4 times with deionized water and then dried in a vacuum oven. This material can be magnetically separated from solution.

### Example 21

### N—TiO₂/PAA|Al(OH)₃

N—TiO₂/PAA nanoparticles were made according to the examples above. 912 mg of freeze-dried N—TiO₂/PAA nanoparticles was completely dissolved in 500 ml deionized water. 5.5 g of Al(NO₃)₃ was dissolved in 400 mL deionized water, and pH was adjusted to 3 by adding 1M NaOH. The N—TiO₂/PAA nanoparticle solution was then added dropwise under vigorous stirring. The pH of this resulting solution was then adjusted to 9 by adding 1M NaOH and then was stirred for ˜30 mins at room temperature. The solids formed were isolated by centrifugation, washed 4 times with deionized water and then air dried. BET isotherm measurements on the dry solid on gave a surface area of 42 m²/g. A certain amount of this material was mixed with either As(V) or Co (II) solution. 8 g of material was capable of removing 12 mg As (V) species from solution. 9 g of material was able to remove 600 mg Co (II) species from solution.

### Example 22

### Al(OH)₃/PAA|Fe₃O₄

Al(OH)₃/PAA nanoparticles were made according to the procedure described above. 912 mg of freeze-dried Al(OH)₃/PAA nanoparticles was completely dissolved in 400 ml deionized water. 5.5 g of FeCl₃ and 1.39 g FeCl₂ was dissolved in 100 mL deionized water, and pH was adjusted to 3 by adding 1M NaOH. The Al(OH)₃/PAA nanoparticle solution was then added dropwise under vigorous stirring. The pH of this resulting solution was then adjusted to 8 by adding 1M NaOH and then was stirred for ˜30 mins at room temperature. The solids formed were isolated by centrifugation, washed 4 times with deionized water and then air dried. A certain amount of this material was mixed with either As(V) or Co (II) solution. 8 g of material was capable of removing 50 mg As (V) species from solution. 9 g of material was able to remove 300 mg Co (II) species from solution. This material can be magnetically separated from solution.

### Example 23

### Fe₂O₃/PAA|SiO₂

Fe₂O₃/PAA nanoparticles were made according to the method described above. 2.5 g of freeze dried Fe₂O₃/PAA was dissolved in 100 mL deionized water. 16.7 g of Na₂SiO₄ solution was dissolved in 50 mL deionized water. The Fe₂O₃ solution was then added to the Na₂SiO₄ solution dropwise under vigorous stirring. The final pH of the mixture was ˜11.4. The pH of the solution was adjusted to 7.0 using 3M HCl. Once the pH has been adjusted to 7, the solution is stirred for 30 mins at room temperature and allowed to sit for 24 hours without stirring. The solid material that settles out of solution is then filtered and washed 4 times though a Büchner funnel. The isolated solid was then dried in a vacuum oven for 24 hours at 80° C. 1 g of this material was mixed with methylene blue solution. 1 g of this material can remove ˜200 mg methylene blue from solution.

### Example 24

### BiVO₄/PAA|SiO₂

BiVO₄/PAA nanoparticles were made according to the procedure described above. 2.5 g of freeze dried BiVO₄/PAA was dissolved in 100 mL deionized water. 16.7 g of Na₂SiO₄ solution was dissolved in 50 mL deionized water. The BiVO₄ solution was then added to the Na₂SiO₄ solution dropwise under vigorous stirring. The final pH of the mixture was ˜11.4. The pH of the solution was adjusted to 7.0 using 3M HCl. Once the pH has been adjusted to 7, the solution is stirred for 30 mins at room temperature and allowed to sit for 24 hours without stirring. The solid material that settles out of solution is then filtered and washed 4 times though a Büchner funnel. The isolated solid was then dried in a vacuum oven for 24 hours at 80° C. 1 g of this material was mixed with methylene blue solution. 1 g of this material can remove ˜200 mg methylene blue from solution. To test for combustion catalyst activity, 100 mg of BiVO₄/PAA|SiO₂ was mixed and ground with 50 mg carbon black. The solid mixture was heated for to 350° C. and maintained for 24 hours in a tube furnace under ambient atmospheric pressure. 5 mg of carbon black was oxidized in this mixture. Without the presence of this material, no carbon black oxidation was observed at this temperature.

### Example 25

### BiVO₄/PAA|CeO₂

BiVO₄/PAA nanoparticles were made according to the procedure described above. 2.5 g of freeze dried BiVO₄/PAA was dissolved in 100 mL deionized water. 4.54 g of Ce(NO₃)₃.6H₂O was dissolved in 90 ml deionized water and 0.6 mL 30% H₂O₂. The BiVO₄/PAA solution was then added dropwise under vigorous stirring. After mixing, the pH of the solution was adjusted to 8 with 1 M NaOH and was stirred at room temperature for 30 mins. The solution was then allowed to sit for 3 hours without any stirring. At the end of three hours, the pH of the solution was then adjusted to 3 with 1 M HCl. The yellow precipitate that formed was isolated by centrifugation and was washed 4 times with deionized water. BET isotherm measurements on the dry solid on gave a surface area of 200 m²/g. 1 g of this material was mixed with methylene blue solution. 1 g of this material can remove 200 mg methylene blue from solution. To test for combustion catalyst activity, 100 mg of BiVO₄/PAA|CeO₂ was mixed and ground with 50 mg carbon black. The solid mixture was heated to 350° C. and maintained for 24 hours in a tube furnace under ambient atmospheric pressure. 45.6 mg of carbon black was oxidized in this mixture. Without the presence of this material, no carbon black oxidation was observed at this temperature. This material is also a very bright yellow pigment.

### Example 26

### Pt/PAA|Pd/PAA|CeO₂

Pt/PAA and Pd/PAA were made according to the procedures described above. 5.5 g of Al(NO₃)₃ was dissolved in 400 mL deionized water, and pH was adjusted to 3 by adding 1M NaOH. 5 mg each of Pt/PAA and Pd/PAA were dissolved in 10 ml deionized water and was added dropwise to the Al(NO₃)₃ solution under vigorous stirring. After the addition, the solution was stirred at room temperature for another 30 mins. The pH of this resulting solution was then adjusted to 9 by adding 1M NaOH and then was stirred for ˜30 mins at room temperature. The solids formed were isolated by centrifugation, washed 4 times with deionized water and then air dried. The solid was then heated in a tube furnace to 600° C. and maintained there for 6 hours under ambient atmospheric pressure. A temperature programmed reaction protocol (TPRx) was used to compare the catalytic oxidation properties of this material against 1% Pt/Al₂O₃. The sample was exposed to air at 500° C. in the reactor, and then cooled to 50-75° C. and the TPRx experiment run to 500° C. at approximately 5° C./min in a flowing gas mixture containing 5% Ar (for calibration purposes), 5% O₂, 2.5% H₂O, 1100 ppm CO or 2250 ppm C₃H₆, all in a balance of He. The flow rate was 95 cc per minute with 0.081 g of sample in the reactor. Lower light off temperature of 50° C. for CO was observed for this material. C3H6 oxidation is commonly used as a probe reaction for lean-burn exhaust catalysts. This material was found to reach 10-85% conversion more rapidly than the 1% Pt/Al₂O₃ sample.

### Example 27

### Pd/PAA|CeO₂

Pd/PAA nanoparticles were made according to the procedure described above. 250 mg of freeze dried Pd/PAA was dissolved in 100 mL deionized water. 2.5 g of Ce(NO₃)₃.6H₂O was dissolved in 90 ml deionized water and 0.3 mL 30% H₂O₂. The Pd/PAA solution was then added dropwise under vigorous stirring. After mixing, the pH of the solution was adjusted to 8 with 1M NaOH and was stirred at room temperature for 30 mins. The solution was then allowed to sit for 3 hours without any stirring. At the end of three hours, the pH of the solution was then adjusted to 3 with 1M HCl. The precipitate that formed was isolated by centrifugation and was washed 4 times with deionized water and dried in a vacuum oven. The Suzuki cross coupling reaction is an extremely versatile methodology for generation of carbon-carbon bonds. Suzuki coupling reactions have huge applications in various fields of chemistry including generation of unnatural amino acids, anti-HIV molecules, glycopeptide antibiotics, functionalization of the walls of carbon nanotubes, copolymerization for photovoltaic devices etc. Pd/PAA|CeO₂ was used for Suzuki cross coupling reactions for making biphenyl compounds. A conversion of 95% at 80° C. was observed in 5 minutes while 100% conversion was achieved in 5 hours using 0.1 mole % of the catalyst at room temperature. Selective oxidation of allylic alcohols to the corresponding carbonyl compounds can also be achieved with this material. A conversion rate of 28% at room temperature in 15 hours using 1 mole % Pd/PAA|CeO₂ catalyst.

### Example 28

### CdTe/PAA|CaCO₃

CdTe/PAA was made according to the procedure described above. 100 mg of CdTe/PAA was dispersed in 100 ml of deionized water. 0.53 g of Na₂CO₃ was dissolved in 20 ml deionized water and was added to the above solution dropwise under vigorous stirring. pH was adjusted to 10.5 using 1M NaOH. 0.74 g of CaCl₂ was dissolved in 20 ml deionized water was then added and the formation of a white precipitate was observed. The solution was stirred for 30 minutes at room temperature. The solid was isolated by centrifugation and washed until no more Cl⁻ ions were detected in the wash. The while solid fluoresces green when exposed to 360 nm light. Photocatalytic hydrogen production activity was evaluated by adding 20 mg of the nanocomposite to 50 ml 20% Methanol/80% water solution. The mixture was exposed to (4) 254 nm UV germicidal lamps (USHIO G25T8). The formation of H₂ bubbles at the nanocomposite-solution interface was observed.

### Example 29

### Fe₂O₃/PAA|Al(OH)₃

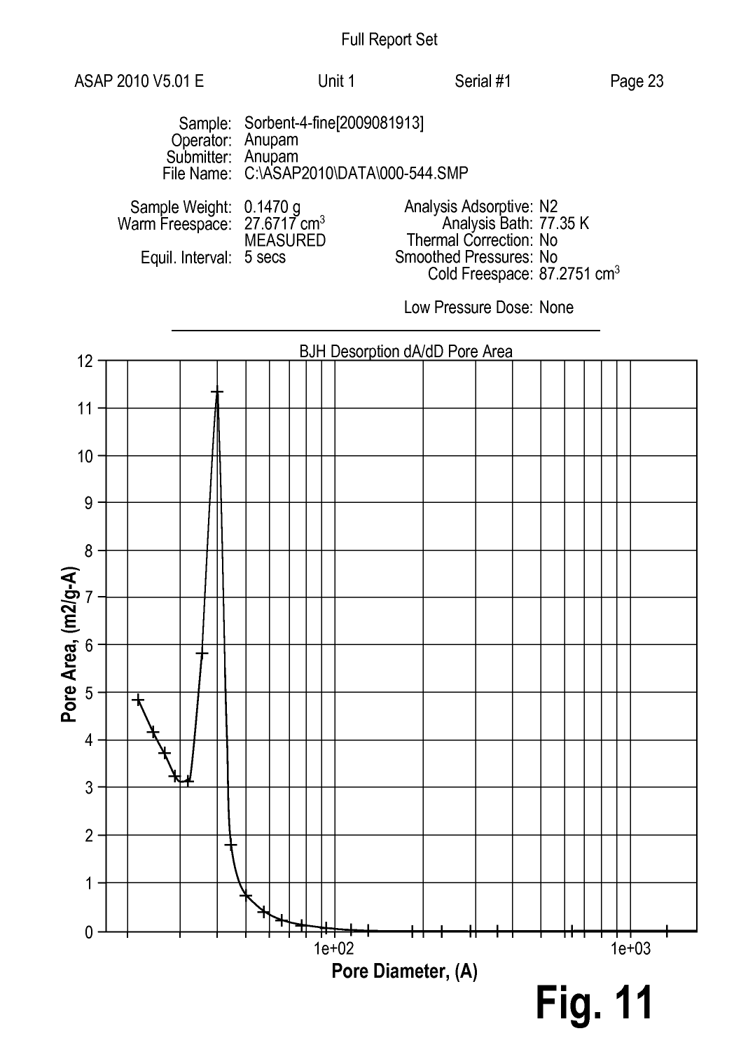

Fe₂O₃/PAA nanoparticles were made according to the procedure described above. 912 mg of freeze-dried Fe₂O₃/PAA nanoparticles was completely dissolved in 500 ml deionized water. 5.5 g of Al(NO₃)₃ was dissolved in 400 mL deionized water, and pH was adjusted to 3 by adding 1M NaOH. The Fe₂O₃/PAA nanoparticle solution was then added dropwise under vigorous stirring. The pH of this resulting solution was then adjusted to 9 by adding 1M NaOH and then was stirred for ˜30 mins at room temperature. The solids formed were isolated by centrifugation, washed 4 times with deionized water and then air dried. BET isotherm measurements on the dry solid on gave a surface area of 143 m²/g. The results of pore size determination is shown in FIG. 11 and shows that pores in the composite are essentially below 50 nm.

### Example 30

### Fe₂O₃/PAA|Fe(OH)₃

Fe₂O₃/PAA nanoparticles were made according to the procedure described above. 67 g of FeCl₃ was dissolved in 200 mL deionized water. The pH of the solution was then adjusted to ˜2 with 3 M NaOH. 8.6 g of Fe₂O₃/PAA nanoparticles was dissolved in 400 mL deionized water and was added to the FeCl₃ solution dropwise. The pH of the resulting mixture was then adjusted to 8 with 3M NaOH. The mixture was then mixed at ambient temperature for 1 hour. The solids formed were isolated by centrifugation. The isolated solid was washed with deionized water 6-7 times until no more Cl⁻ ions was detected in the wash. The solid was dried in a vacuum oven. 1 g of this material was mixed with methylene blue solution. 1 g of this material can remove ˜200 mg methylene blue from solution. 5 g of this material was mixed with C₈H₄K₂O₁₂Sb₂.xH₂O (Antimony potassium tartrate) solution and agitated on a shaker for 24 hours. 5 g of this material was able to remove 180 mg of Sb (III) species from solution.

### Example 31

### Pt/PAA|C and Pt|C

Pt/PAA nanoparticles were made according to Example 6. An aqueous suspension (16 ml) of the nanoparticles (26 mg) and carbon black Vulcan XC 72R (985 mg) was sonicated for 6 min in a 50 ml plastic centrifuge tube. Dioxane (32 ml) was added and the tube was vortexed for 15 min and then centrifuged for 15 min at 3,500 rpm. The clear colourless supernatant was discarded and the precipitate was twice re-suspended in 25 ml dioxane, centrifuged and decanted. The black paste was dried in vacuum at 60-70° C. to the constant weight.

The black solid was heated in nitrogen at 600° C. for to 10. When the resultant black powder was re-suspended in water and centrifuged the supernatant was completely colourless. The yield of the calcified solid was 981 mg. The content of Pt in the solid was 0.69% (ICP).

### Example 32

### Fe₃O₄/PAA|C and Fe₃O₄|C

Fe₃O₄/PAA nanoparticles were made according to Example 2. The nanoparticles (400 mg) were dispersed in water (15 ml) in a 50 ml plastic centrifuging tube. Carbon black Vulcan XC 72R (400 mg) was added followed by 15 min vortexing of the suspension to break up aggregates. Methylethylketone (30 ml) was added and the suspension was vortexed for 10 min followed by 20 min centrifugation at 3,500 rpm. The clear and colourless supernatant was discarded and the precipitate was washed twice with absolute ethanol (30 ml×2). The washed black solid was dried in vacuum at 70° C. to constant weight (800 mg).

After calcifying in nitrogen at 600° C. for 10 h the black powder was re-suspended in water. The suspension was centrifuged. The supernatant was completely clear. All black solid followed a magnet. The solid was stable in the pH range of 2-9. Concentrated hydrochloric acid will leach the magnetite nanoparticles from the nanocomposite leaving non-magnetic carbon support

### Example 33

### Fe₃O₄/PAA|SiO2 and Fe₃O₄|SiO2

Ferromagnetic silica particles (snowtex 20 L) were made in accordance with procedures described above. Calcination of the co-precipitate (air, 600° C., 10 h) resulted in brown-coloured silica particles that were magnetic in aqueous media. This result is unexpected as the calcination of bulk magnetite at the same conditions, fully converts it to a non-ferromagnetic iron(III) oxide.

### Example 34

### Ceria/PAA|Al(OH)₃ and CeO2|Al2O3

Fe₃O₄/PAA nanoparticles were made in accordance with the protocol described above. Aluminum nitrate nonahydrate (33.529 g) was dissolved in 320 ml DI water. To the resultant solution an aqueous dispersion of ceria/PAA nanoparticles containing 1.14 g nano-ceria and 4.64 g PAA in 200 ml water was added. The pH of the produced dispersion was shifted from 3.1 to 7.5 with 3.0 N aqueous NaOH. The suspension obtained was evenly distributed in four 250 ml plastic jars and centrifuged 20 min at 3,500 rpm. The clear colourless supernatant was discarded. The paste-like precipitates were washed with DI water (200 ml, 2 times), diluted acetic acid (200 ml water+precipitate+50% aqueous acetic acid to the pH of 4.3, 2 times) and finally again with DI water (200 ml, once). After each washing the suspension was centrifuged. The last supernatant contained only about 15-20 ppm nitrates (a strip test) and no chlorides (a visual test with an aqueous silver nitrate). All four washed precipitates were combined and re-dispersed in water. The resultant suspension, 288.26 g, contained 3.95 mg/g nano-ceria, 16.10 mg/g stabilizing PAA and 24.19 mg/g aluminum hydroxide. A part of the suspension (36.3 g) was taken off for oxidation tests. The rest was centrifuged and dried at 60 to constant weight, 11.16 g.

The yellow solid produced was ground in a mortar and then calcified in air at 450° C. for 10 h plus a 10 h ramp from the room temperature to 450° C. The calcination resulted in 6.16 g weight loss, in line with loss of PAA and the conversion of aluminum hydroxide to alumina.

### Example 35

### BiVO₄/PAA|SiO2

BiVO₄/PAA nanoparticles on silica were made in accordance with the protocol described above. After the initial reaction mixture was filtered the precipitate was washed on the filter with 0.001N aqueous hydrochloric acid till the pH of the eluent became 3.0. Then DI water was passed through the precipitate till the complete absence of the chlorides in the eluent. These washings resulted in the removal most PAA and all sodium from the precipitate. The precipitate was dried on the filter and finally in vacuum at 50-70° C. over KOH. Dried solid was ground in a mortar and then calcified in air for 5 h at 500° C. The calcinated product, 4.96 g, was a very bright yellow pigment. The intensity of its colour almost matched the intensity of the commercial bismuth vanadate, which is also calcinated at the same conditions during manufacturing, although the composite pigment contained only 10% of the bismuth vanadate. Bismuth vanadate is one of the most expensive yellow pigments which is used instead is much less expensive but much more toxic lead chromate and cadmium sulfide. Encapsulation of bismuth vanadate nanoparticles in the bigger silica particles does not only decrease the price of the pigment significantly but also suppress the photocatalytic activity of bismuth vanadate which slowly degrades the polymer binders in paints then a coating is exposed to the light.

### Example 36

### Electrode Position of Nanoparticles to form Coated-Type Nanocomposite

Composite BiVO₄/PAA nanoparticles were made according to the procedure described above. In a beaker fitted with a magnetic stirring bar and containing a 2% aqueous dispersion of the nanoparticles two iron nails were inserted. The nails were kept apart in the dispersion. Then an electrolysis cell was made by attaching one nail to a negative pole of a 24 V DC source while the other nail was connected to a positive pole of the battery. In 30 sec both poles was removed from the dispersion. The nail attached to the anode, a positive pole in this set up, had an even yellow coating comprised from BiVO₄/PAA nanoparticles. The other electrode did not have the coating.

The nanoparticles collapsed onto the anode due to the following reaction in its vicinity: H₂O−2 e=2H⁺+½ O₂. The released protons decreased the degree of ionization of stabilizing PAA shells surrounding the nanoparticles that kept them in the dispersion.

The same coating was made with ZnCrO₄/PAA nanoparticles. Zinc chromate is known to be one of the most efficient anticorrosive agents. So when the ZnCrO₄/PAA nanoparticles are added to a standard anaphoretic aqueous primer composition the resultant coating will have enhanced resistance to corrosion.

To induce the electrodeposition of nanoparticles onto negatively charged surfaces, the positively charged polymers, such as polyallylamine hydrochloride, should be used when the composite nanoparticles are synthesized.

### Example 37

### CeO2/PAA|Al(OH)₃ and CeO2|Al2O3

On a 16 cm² part of a ceramic tile a suspension of nano-ceria/PAA on alumina hydroxide, containing 41 mg nano-ceria, 164 mg PAA and 251 mg aluminum hydroxide, was applied. On another 16 cm² part of the same tile a control, 164 mg PAA (MW of 1,800 g/mol) in 4 ml water was applied. The tile was dried at 60° C. and then calcified in a tubular quartz furnace in air flow heated at the rate of 1.37° C./min.

When heated the yellow spot with nano-ceria/PAA on aluminum hydroxide started changing colour. It became darker at 200° C. After 300° C. the darkness started fading and at 400° C. the catalyst layer became again fully yellow. The control spot started changing the colour only at about 350° C., became the mostly dark, almost black, at 450° C. And at 500° C. the control spot, pure PAA on the tile, was still brownish. So the catalyst, nano-ceria on aluminum hydroxide, decreased the temperature of PAA volatilization for at least 100° C.

After the first heating run other portions of aqueous PAA solutions were applied onto the both spots and the heat treatment was repeated. And again the complete volatilization of PAA occurred on the spot containing the catalyst—in this case nano-ceria on alumina since aluminum hydroxide converts into alumina at temperature above 430° C.-100-150° C. earlier as compared to the control spot. The same elect was observed in the third heating run too.

### Example 38

### Fe₂O₃/PAAH

A solution of 1.02 g FeCl₃.6H₂O dissolved in 1.6 L deionized water was added dropwise to a solution of 3.40 g polyallylamine hydrochloride (60K MW) in 1.6 L deionized water. The solution was stirred for 30 min at room temperature. The solution was then irradiated under 254 nm UV germicidal lamps (USHIO G25T8) until it was filterable through a 0.2 micron syringe filter. The pH of the solution was then increased to 8.9 with 1 M NaOH.

### Example 39

### Fe₂O₃/PAAH|Fe₂O₃ (15:85 Fe₂O₃: PAAH; 30:70 np:matrix)

7.96 g of FeCl₃.6H₂O was dissolved in 350 mL deionized water. To this was added 1.6 L of Fe₂O₃/PAAH nanoparticle solution (as prepared above) containing 2 g of nanoparticles. The pH of the resulting solution was increased to 10.5 with 1M NaOH. The material was stored in a slurry form at room temperature.

### Example 40

### Fe₂O₃/PAAH|Rice Husk Ash

2 g of powdered rice husk ash was treated with 20 mL of 1 M NaOH. The solid was collected by centrifugation and was added to 675 mL of Fe₂O₃/PAAH nanoparticle solution (as prepared above) containing 500 mg of nanoparticles. The pH of the solution was increased to 10.5 with 1 M NaOH and 5 g of NaCl was added. The mixture was stirred for 1 h at room temperature.

### Example 41

### TiO₂/PAAH|Fe₂O₃

683 mg of FeCl₃.6H₂O was dissolved in 30 mL deionized water. 102 mg of freeze dried Ti0₂/PAAH was dissolved in 20 mL deionized water and then added slowly to the Fe solution. The pH of the resulting solution was increased to 8.55 with 1M NaOH and then stirred for ˜30 min at room temperature. The brown solid was collected by centrifugation, washed 5 times with deionized water and dried in a vacuum oven.

### Example 42

### PAA|Al2O3

A 0.2 wt % solution of PAA polymer was created by adding 2 g of solid polymer to 1 L of deionized water and increasing the pH of the solution to 6.00 in order to dissolve the polymer. 100 mL of 3 M NaCl was added and the solution was stirred for 30 min at room temperature. The solution was then irradiated under 254 nm UV germicidal lamps (USHIO G25T8) for 2 h. The solution was dialyzed and the nanoparticles of polymer were collected by freeze drying

2.5 g of PAA dissolved in 80 mL deionized water and to this solution was added 3.3 g Sasol Dispal HP14 (Al2O3) powder which had been previously peptized (The peptize procedure: 3.3 g Sasol powder was suspended in 60 mL deionized water and to this was added 1.8 mL of 1.5 N HNO3. The solution was stirred for 30 min at room temperature and filtered.) The mixture was stirred for one hour and then subsequently stored as a slurry.

### Example 43

### P(MAA-co-EA) Nanoparticles|Al2O3

A 0.2 wt % solution of poly(90% methylmethacrylate-co-10% ethylacetate) (P(MAA-co-EA) 90:10) polymer was created by adding 2 g of solid polymer to 1 L of deionized water and increasing the pH of the solution to 6.00 in order to dissolve the polymer. 100 mL of 3 M NaCl was added and the solution was stirred for 30 min at room temperature. The solution was then irradiated under 254 nm UV germicidal lamps (USHIO G25T8) for 2 h. The solution was dialyzed and the nanoparticles of polymer were collected by freeze drying.

To 100 mL of a 5 wt % P(MAA-co-EA) nanoparticles solution was added 6.25 g Sasol powder, peptized as above. The pH of the mixture was lowered to 2.0 with 1 M HCl and the mixture was stirred for 1 h at room temperature. The product was stored as a slurry.

### Example 45

### P(MAA-co-EA) Particle (90% MAA/10% EA) Without Irradiation

Example 43 was reproduced but without the UV irradiation on the polymer. The nanocomposite was purified by dialysis and recovered by freeze-drying.

### Example 46

### P(MAA-co-PS)|Al₂O₃

To 100 mL of a 1 wt % P(MAA-co-PS) solution was added 1.25 g Sasol powder, peptized as above. The pH of the mixture was lowered to 2.0 with 1 M HCl and the mixture was stirred for 1 h at room temperature. The product was stored as a slurry.

### Example 49

### P(MAA-co-EA) without UV|Al₂O₃

Example 43 was repeated except without UV irradiation of the polymer solution. The nanocomposite was purified by dialysis and recovered by freeze-drying.

Various uses of the nanocomposites of the invention, such as catalytic oxidation, ion exchange for removal of toxic metals, removal of oil from water with nanoparticle-magnetized carbon.

### Example 50

### Use of Nanocomposites in Catalytic CO Oxidation

Approximately 0.4 g of 1% by weight of Pt/Pd in the form of Pt/Pd|CeO2, prepared in accordance with Example 26 and and cacincated at 400° C., was placed in a Hilden Catlab Reactor System equipped with a Hiden QIC-20 Mass spectrometer and a CO/O2-enriched gas stream was passed over the catalyst. The catalytic reaction zone was heated at a rate of 10° C./min from room temperature to 500° C. The gas stream was continuously monitored for carbon monoxide content.

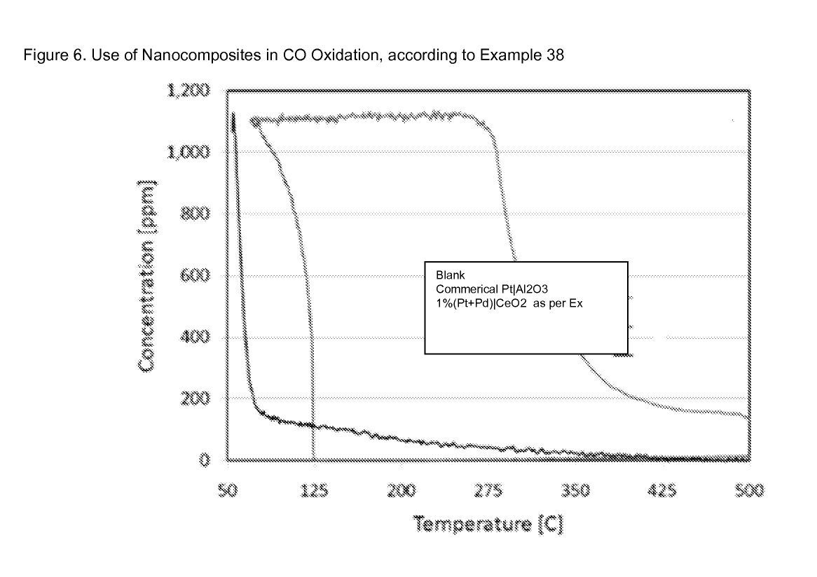

The experiment was repeated without a catalyst and with 1% Pt from a commercial grade Pt/gamma-alumina (Alfa Aesar). The results shown in FIG. 6 show the strong initial, low-temperature activity of the nanocomposite catalyst of the invention. This reactivity could have a positive impact on reducing auto emissions at start-up when the catalyst has not yet attained the higher temperatures needed for conventional catalysts. Other catalysts that were tested and found active include: Pt|CeO2, Pd|Al2O3, BiVO4|Al2O3 prepared according to methods described above.

### Example 51

### Use of Nanocomposites in Catalytic Propylene Oxidation

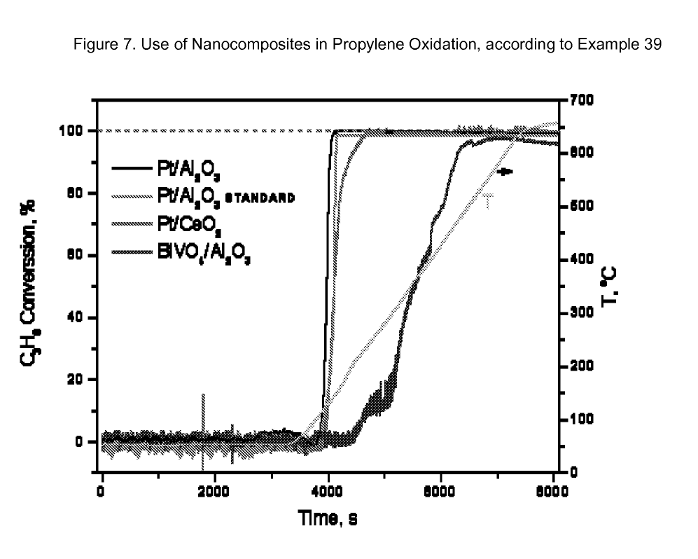

Using a similar experimental set-up as in Example 38, Pt|CeO2, Pt|Al2O3, BiVO4|Al2O3 and commercial Pt|Al2O3 were contacted in separate experiments with a stream of propylene and oxygen. The catalyst in each case was heated at a rate of 10° C./min from room temperature to 650° C. The exiting gas stream was monitored for unconverted propylene. The results of the experiments are shown in FIG. 7. Each of the catalysts was active in promoting the oxidation of propylene and the order to reactivity from most reactive to least reactive: Pt|Al2O3 according to the invention >Pt|Al2O3 commercial standard >Pt|CeO2>>BiVO4|Al2O3.

### Example 52

### Use of Nanocomposites in Catalytic Oxidative Coupling of Methane

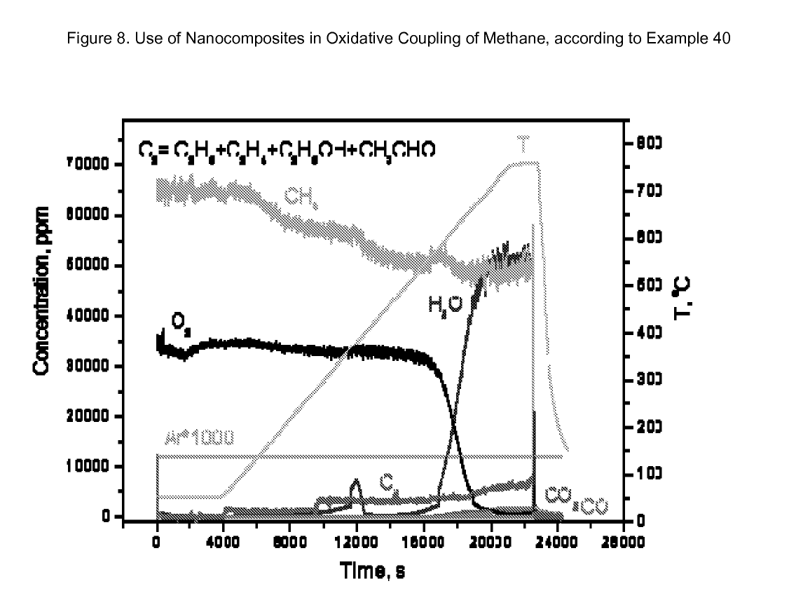

Using a similar experimental set-up as in Example 39, BiVO4|Al2O3 was contacted with a stream of methane and oxygen. The catalyst was heated at a rate of 10° C./min from room temperature to 750° C. The exiting gas stream was monitored for unconverted oxygen and methane as well as by-products of the reaction including water, CO, CO2 and C2 products such as ethane, ethylene, ethanol and acetaldehyde. The results of the experiments are shown in FIG. 8. Methane conversion commenced at about 150° C. was maximimal (26-27%) above 650° C. The yield of combined C2 products was ˜17% (max) at the highest temperatures with ethylene as the major product.

### Example 53

### Use of Nanocomposites in Oxidative Dehydrogenation of Propane

Pt|Al2O3 and BiVo4|Al2O3 prepared according to the methods described above were tested for propylene dehydrogenation in a stream of propylene and oxygen and compared to a commercial grade of Pt|Al2O3 as a reference in a variable temperature flow through reaction chamber. The chamber was heated at a rate of 10° C./min from room temperature to 650° C. and propylene gas was monitored. The results shown in FIG. 7 show that the reactivity Pt catalyst of the invention closely resembles the commercial product and that BiVO4|Al2O3 can achieve similar conversions but only at temperatures above 550° C.

### Example 54

### Use of Nanocomposites in Photo-Oxidation of Toluene

N-doped TiO2/PAA|Al2O3 prepared according to Example 21 was coated on a 30×30 cm metal mesh screen and placed in a continuous flow through reactor equipped with an in-line Hiden QIC-20 Mass spectrometer at the entrance and the exit of the reaction zone. Air was pushed through a saturation chamber (containing excess toluene) to the reactor at a rate of 25 CFM and the reaction zone was irradiated through a quartz window onto the mesh using a 2.4-watt 365 nm LED UV lamp operating at full power. The entering and exiting gases were monitored for toluene. The conversion rates were the following: no catalyst on screen 4.3% conversion <N-doped TiO2/PAA|Al2O3 of the invention 11.2%˜commercial TiO2 11.5%.

### Example 55

### Use of Nanocomposites for Ion Exchange

In a 250 ml Nalgene Plastic bottle, 100 mg of Nano Fe₃O₄(−) on Fe₃O₄sorbent was taken. To it 100 ml of 0.00333(M) of respective salt solution was added. The mixture was shaken in an Orbital Shaker 400 RPM, VWR at room temperature for 2 hours. A 20 ml of the solution was syringed out from the bottle and centrifuged in GS-6R Beckman Centrifuge at 3500 rpm. The supernatant was analyzed in Inductive coupled plasma spectroscopy.

| | Calcium | Cadmium | Cobalt | Lead | Zinc |
|---|---|---|---|---|---|
| Ion | removed | removed | removed | removed | removed |
| Exchange | g/kg of | g/Kg of | g/kg of | g/kg of | g/kg of |
| Resin | resin | resin | resin | resin | resin |
| Nano | 24 | 154 | 60 | 220 | 89 |
| Fe₃O₄(−) | | | | | |
| on Fe₃O₄ | | | | | |

Mixture of Equi-molar amount of metal salts

| | | | | | |
|---|---|---|---|---|---|
| Nano | 2 | 26 | 4 | 130 | 8 |
| Fe₃O₄(−) | | | | | |
| on Fe₃O₄ | | | | | |

### Example 56

### Removing Oil on Water with Magnetic Nanoparticle-Magnetized Carbon

Fe₃O₄/PAA nanoparticles were made in accordance with the protocol described above. The nanoparticles contained ca.35% nano-magnetite. The freeze-dried nanoparticles (114 g) were loaded into two alumina combustion boats. The boats were calcified in a tubular furnace in nitrogen. The heating profile was as follows: 10 h from the room temperature to 600° C. and then 10 h at 600° C. Following the calcinations the black solid lost about 30% of its initial weight due to carbonization of PAA and contained 50% nano-magnetite surrounded by carbon shells. The black solid was ground in a mortar.

A sample imitating crude oil was prepared by mixing 9 wt. parts of vegetable oil and 1 wt. part of roof patch tar “Black Knight”. The resultant black composition was place in a beaker filled with water. The composition floated on the surface of water. Grounded carbonized Fe₃O₄/PAA nanoparticles (1 wt part) were dispersed evenly over the surface of the oil imitation spill and in 15 min a permanent magnet was placed near the outside wall of the beaker. All black oily suspension immediately assembled near the wall contacting the magnet leaving the water surface in the beaker free of oil. The oil could be easily collected with a spoon spatula or a suction pipette from a small area near the magnet.

Collected oil can be burned as a fuel leaving ferric oxide as the only residue which is completely non-toxic. The interaction of oil with carbonized nano-magnetite and attraction of treated oil to the magnet can be controlled by the ratio of nano-magnetite to PAA in the composite nanoparticles. If nanoparticles with larger magnetic moment are needed, the manganese ferrite nanoparticles, MnFe₂O₄/PAA, can be used instead of nano-magnetite/PAA.

### Example 57

### Use of Nanocomposites for Removal of an Organic Dye From Solution

P(MAA-co-EA) capsules|Al₂O₃ was prepared according to Example 46. 10 mL of 6.5 mg/mL sorbent slurry solution was combined with 100 mL of a 0.05 wt % solution of yellow dye 74 in a 250 mL Nalgene plastic bottle (290.2 mg/L). The mixture was shaken for 30 min at room temperature at a speed of 4 by a Vortex-Genie 2. The mixture sat for 30 min at room temperature before being centrifuged in a GS-6R Beckman Centrifuge at 3500 rpm. Analysis of the supernatant (13.9 mg/L) showed a reduction a reduction of 95% of the amount of organic dye.

### Equivalents

The foregoing has been a description of certain non-limiting embodiments of the invention. Those skilled in the art will recognize, or be able to ascertain using no more than routine experimentation, many equivalents to the specific embodiments of the invention described herein. Those of ordinary skill in the art will appreciate that various changes and modifications to this description may be made without departing from the spirit or scope of the present invention, as defined in the following claims.

In the claims articles such as “a,”, “an” and “the” may mean one or more than one unless indicated to the contrary or otherwise evident from the context. Claims or descriptions that include “or” between one or more members of a group are considered satisfied if one, more than one, or all of the group members are present in, employed in, or otherwise relevant to a given product or process unless indicated to the contrary or otherwise evident from the context. The invention includes embodiments in which exactly one member of the group is present in, employed in, or otherwise relevant to a given product or process. The invention also includes embodiments in which more than one, or all of the group members are present in, employed in, or otherwise relevant to a given product or process. Furthermore, it is to be understood that the invention encompasses all variations, combinations, and permutations in which one or more limitations, elements, clauses, descriptive terms, etc., from one or more of the claims or from relevant portions of the description is introduced into another claim. For example, any claim that is dependent on another claim can be modified to include one or more limitations found in any other claim that is dependent on the same base claim. Furthermore, where the claims recite a composition, it is to be understood that methods of using the composition for any of the purposes disclosed herein are included, and methods of making the composition according to any of the methods of making disclosed herein or other methods known in the art are included, unless otherwise indicated or unless it would be evident to one of ordinary skill in the art that a contradiction or inconsistency would arise. In addition, the invention encompasses compositions made according to any of the methods for preparing compositions disclosed herein.

Where elements are presented as lists, e.g., in Markush group format, it is to be understood that each subgroup of the elements is also disclosed, and any element(s) can be removed from the group. It is also noted that the term “comprising” is intended to be open and permits the inclusion of additional elements or steps. It should be understood that, in general, where the invention, or aspects of the invention, is/are referred to as comprising particular elements, features, steps, etc., certain embodiments of the invention or aspects of the invention consist, or consist essentially of, such elements, features, steps, etc. For purposes of simplicity those embodiments have not been specifically set forth in haec verba herein. Thus for each embodiment of the invention that comprises one or more elements, features, steps, etc., the invention also provides embodiments that consist or consist essentially of those elements, features, steps, etc.

Where ranges are given, endpoints are included. Furthermore, it is to be understood that unless otherwise indicated or otherwise evident from the context and/or the understanding of one of ordinary skill in the art, values that are expressed as ranges can assume any specific value within the stated ranges in different embodiments of the invention, to the tenth of the unit of the lower limit of the range, unless the context clearly dictates otherwise. It is also to be understood that unless otherwise indicated or otherwise evident from the context and/or the understanding of one of ordinary skill in the art, values expressed as ranges can assume any subrange within the given range, wherein the endpoints of the subrange are expressed to the same degree of accuracy as the tenth of the unit of the lower limit of the range.

In addition, it is to be understood that any particular embodiment of the present invention may be explicitly excluded from any one or more of the claims. Any embodiment, element, feature, application, or aspect of the compositions and/or methods of the invention can be excluded from any one or more claims. For purposes of brevity, all of the embodiments in which one or more elements, features, purposes, or aspects is excluded are not set forth explicitly herein.

### Incorporation by Reference

All publications and patent documents cited in this application are incorporated by reference in their entirety for all purposes to the same extent as if the contents of each individual publication or patent document were incorporated herein.

1. A multifunctional nanocomposite comprising at least two components, at least one component of which is a nanoparticle comprising a polymer and the other component comprises an inorganic phase.

2. The multifunctional nanocomposite of claim 1, wherein the polymer of the nanophase is crosslinked.

3. The multifunctional nanocomposite of claim 1, wherein the nanoparticle is between about 1 nm and about 20 nm in size.

4. The multifunctional nanocomposite of claim 1, wherein the nanoparticle is less than about 50 nm in size.

5. The multifunctional nanocomposite of claim 1, wherein the nanoparticle is less than about 100 nm in size.

6. The multifunctional nanocomposite of claim 1, wherein the nanoparticle is a polymer-stabilized inorganic nanoparticle.

7. The multifunctional nanocomposite of claim 1, wherein the polymer comprises a polyelectrolyte.

8. The multifunctional nanocomposite of claim 1, wherein the nanoparticle component is dispersed uniformly throughout the inorganic phase.

9. The multifunctional nanocomposite of claim 1, wherein the nanoparticles are unevenly dispersed throughout the nanocomposite.

10. The multifunctional nanocomposite of claim 1, wherein the nanoparticles are resistant to sintering at elevated temperatures.

11. The multifunctional nanocomposite of claim 1, wherein the secondary inorganic phase is selected from the group consisting of amorphous carbon, pyrolytic carbon, activated carbon, charcoal, ash, graphite, fullerenes, nanotubes and diamond.

12. The multifunctional nanocomposite of claim 1, wherein the secondary inorganic phase is selected from the group consisting of metal oxides, mixed metal oxides, metal hydroxides, mixed metal hydroxides, metal oxyhydroxides, mixed metal oxyhydroxides, metal carbonates, tellurides and salts.

13. The multifunctional nanocomposite of claim 1, wherein the secondary inorganic phase is selected from the group consisting of titanium dioxide, iron oxide, zirconium oxide, cerium oxide, magnesium oxide, silica, alumina, calcium oxide and aluminum oxide.

14. The multifunctional nanocomposite of claim 1, wherein the nanocomposite is porous.

15. The multifunctional nanocomposite of claim 1, wherein the nanocomposite has a surface area greater than about 100 m²/g.

16-18. (canceled)

19. The multifunctional nanocomposite of claim 1, wherein the nanocomposite is a catalyst.

20. The multifunctional nanocomposite of claim 1, wherein the nanocomposite comprises multiple types of catalysts.

21. The multifunctional nanocomposite of claim 1, wherein the nanocomposite is photocatalyst.

22. The multifunctional nanocomposite of claim 21, wherein the nanocomposite is photocatalyst when exposed to visible light.

23. The multifunctional nanocomposite of claim 22, wherein the nanocomposite is capable of producing hydrogen when irradiated with light.

24. The multifunctional nanocomposite of claim 1, wherein the nanocomposite is an oxidation catalyst.

25. The multifunctional nanocomposite of claim 1, wherein the nanocomposite comprises more than about 10% nanoparticle by weight.

26-27. (canceled)

28. The multifunctional nanocomposite of claim 1, wherein the nanocomposite comprises more than about 30% polymer-stabilized nanoparticle by volume.

29-30. (canceled)

31. The multifunctional nanocomposite of claim 1, wherein the nanoparticle comprises an inorganic phase stabilized by a polymeric phase.

32. The multifunctional nanocomposite of claim 1, wherein the nanoparticle component is capable of sorption of organic substances.

33. The multifunctional nanocomposite of claim 1 wherein the nanoparticles is capable of participating in ion exchange.

34. (canceled)

35. The nanocomposite of claim 33, wherein the nanocomposite can remove more than about 100 grams of charged contaminant from aqueous solution per gram of nanocomposite.

36-37. (canceled)

38. The nanocomposite of claim 33, wherein the nanocomposite can participate in cation exchange, anion exchange, or both.

39-40. (canceled)

41. The multifunctional nanocomposite of claim 1, wherein the inorganic phase is capable of being magnetically separated.

42. A nanocomposite comprising at least two components, at least one component of which is a nanoparticle comprising a polymer and the second component comprising an inorganic phase, which is prepared by pyrolysis at a temperature >150° C. and sufficient to induce partial or complete decomposition of the polymer of the nanophase.

43-48. (canceled)

49. A method to produce nanocomposite materials, comprising the steps of (a) dispersing nanoparticles in a suitable solvent; (b) adding at least one precursor component which can lead to the formation of an inorganic phase to the solvent; and (c) modifying the at least one precursor component of the inorganic precursor to form a nanocomposite.

50-56. (canceled)

57. A method to produce nanocomposite materials, comprising the steps of (a) dispersing nanoparticles in a suitable solvent; (b) adding an inorganic secondary phase to the dispersion; (c) adding an agent or combination of agents that promote interaction of the nanoparticles and the secondary phase; and (d) recovering the nanocomposite.

58-68. (canceled)

69. A method to produce nanocomposite material comprising pyrolysis of a nanocomposite comprising an inorganic phase and polymer-stabilized nanophase in order to partially or completely eliminate the polymer component of the nanophase.
